(19) United States
(12) Patent Application Publication
(10) Pub. No.: US 2026/0178400 A1
(43) Pub. Date: Jun. 25, 2026

(54) MANAGEMENT SYSTEM AND METHOD EXECUTED BY MANAGEMENT SYSTEM

(71) Applicant: Hitachi Vantara, Ltd., Kanagawa-ken (JP)

(72) Inventors: Mitsuo HAYASAKA, Tokyo (JP); Yuto KAMO, Tokyo (JP)

(21) Appl. No.: 19/324,946

(22) Filed: Sep. 10, 2025

(30) Foreign Application Priority Data
Dec. 20, 2024 (JP) 2024-225529

(51) Int. Cl. G06F 9/50

(52) U.S. Cl. CPC G06F 9/5038

(57) ABSTRACT

A job analysis unit analyzes a workflow of a job before starting execution of the job to specify data to be read when a calculation resource executes the job. A prefetch management unit performs control to start prefetch from a secondary storage to the primary storage for data of which no data entities exist in the primary storage and data entities exist in the secondary storage, among the data specified by the job analysis unit for the job.

### CROSS REFERENCE TO RELATED APPLICATION

This application relates to and claims the benefit of priority from Japanese Patent Application number 2024-225529, filed on December 20, 2024 the entire disclosure of which is incorporated herein by reference.

### BACKGROUND OF THE INVENTION

### 1. Field of the Invention

The present disclosure relates to a technology for prefetch of data between storages.

### 2. Description of the Related Art

A storage that stores data to be read when a job is executed may be configured in a plurality of hierarchies with respect to a calculation resource that executes processing for the job.

For example, in order to train a model for realizing artificial intelligence (AI), there may be provided an integrated platform including a compute server that forms a calculation resource and a storage that stores data to be read when a job is executed, so as to perform model parameter optimization processing (big data analysis processing) using learning data including big data or the like, or so as to perform preprocessing on the learning data before the optimization processing (analysis processing). The integrated platform may include a file storage as a primary storage that is a first hierarchy of the storage (a hierarchy relatively close to the calculation resource (compute server)), and an object storage as a secondary storage that is a next hierarchy of the storage (a hierarchy relatively far from the calculation resource (compute server)). Alternatively, the integrated platform may include a calculation resource (compute server) and a primary storage, and transfer data to and from a secondary storage outside the integrated platform.

In a case where the storage is configured in a plurality of hierarchies as described above, when a data entity of data to be read when the calculation resource (e.g., compute server) executes a job does not exist in the primary storage but exists in the secondary storage, the data entity needs to be transferred from the secondary storage to the primary storage. When the above-described transfer is performed, there is a possibility that the calculation resource (e.g., the compute server) may stand by until the data entity of the data to be read when the job is executed exists in the primary storage (that is, an input/output bottleneck may occur).

In order to minimize the stand-by when the calculation resource (e.g., compute server) executes a job, it is useful to perform control such that a data entity of data to be read when the calculation resource executes the job already exists in a storage (primary storage) in a hierarchy relatively close to the calculation resource at the time when the calculation resource executes the job. To this end, it may be considered that the data entity of the data to be read when the calculation resource executes the job is transferred in advance (prefetched) from the storage (secondary storage) in the hierarchy relatively far from the calculation resource to the storage (primary storage) in the hierarchy relatively close to the calculation resource.

US 10084877 B2 is a prior art document relating to prefetch of data. US 10084877 B2 discloses a technology in which a graph indicating an access context between accessed data is recorded based on a past access history, and when certain data is accessed, data estimated to be highly likely to be accessed subsequently is subjected to prefetch control by using the information of the graph.

### SUMMARY OF THE INVENTION

Even if it is assumed that the prior art relating to the prefetch control disclosed in US 10084877 B2 is applied to a system including a calculation resource (e.g., compute server) and a storage configured in a plurality of hierarchies, a long stand-by may occur when the calculation resource executes a job. Specifically, in the case assumed above, when the calculation resource (compute server) starts executing a job and actually accesses certain data, a process is started to transfer (prefetch) a data entity of data estimated to be highly likely to be accessed subsequently from a storage (secondary storage) in a hierarchy relatively far from the calculation resource to a storage (primary storage) in a hierarchy relatively close to the calculation resource. At this time, depending on the relationship between the processing capability of the calculation resource (compute server) itself, the speed of data transfer from the primary storage to the calculation resource (compute server), and the speed of data transfer from the secondary storage to the primary storage, it may be a timing at which the calculation resource (compute server) reads the data and performs processing before the data entity to be prefetched exists in the primary storage, and the calculation resource (compute server) may stand by.

When the calculation resource (compute server) stands by for executing the job as described above, the time required for the execution of the job increases (the job execution performance deteriorates). For example, in a case where the calculation resource (compute server) executes processing for the job to perform model parameter optimization processing (big data analysis processing) using learning data including big data or the like, or to perform preprocessing on the learning data before the optimization processing (analysis processing), the time required for the model parameter optimization processing (big data analysis processing) or the preprocessing on learning data increases.

In view of the above, one of the objects of the present disclosure is to increase the possibility that a storage in a hierarchy relatively close to the calculation resource holds data at the timing when the data is used to execute the job.

In order to achieve at least one of the above objects, the features of the present disclosure are, for example, as follows.

One aspect of the present disclosure is a management system. The management system is for managing a calculation resource and a storage. The management system includes a job analysis unit and a prefetch management unit. The job analysis unit analyzes a workflow of a job before starting execution of the job to specify data to be read when the calculation resource executes the job. The prefetch management unit performs control to start prefetch from a secondary storage to a primary storage for data of which no data entities exist in the primary storage having relatively high performance of access from the calculation resource and data entities exist in the secondary storage having relatively low performance of access from the calculation resource, among the data specified by the job analysis unit for the job.

In view of the above, according to the present disclosure, it is possible to increase the possibility that a storage in a hierarchy relatively close to the calculation resource holds data at the timing when the data is used to execute the job.

A method and a program that realize the same processing as that realized by the management system can also obtain the same effects as those of the management system. In a program aspect, the cost is reduced in many cases. In the program, design modifications regarding processing are also easily performed.

Features that can be included in the present disclosure other than those described above and effects corresponding to the features are disclosed in the specification, claims, or drawings.

### BRIEF DESCRIPTION OF THE DRAWINGS

FIG. 1 illustrates a basic functional configuration in an embodiment of the present disclosure;

FIG. 2 illustrates an overall configuration of a first embodiment;

FIG. 3 illustrates a process performed by a job analysis unit;

FIG. 4 illustrates an example of a workflow of a job;

FIG. 5 illustrates an example of a command for calling a job;

FIG. 6 illustrates an example of a job setting file;

FIG. 7 illustrates job analysis information;

FIG. 8 illustrates a process performed by an investigation unit;

FIG. 9 illustrates a data (file) state;

FIG. 10 illustrates a process performed by a file and object management unit;

FIG. 11 illustrates a process performed by a prefetch request unit;

FIG. 12 illustrates a process performed by a prefetch management unit;

FIG. 13 illustrates a process performed by a job assignment unit;

FIG. 14 illustrates a scheduling policy setting file;

FIG. 15 illustrates a process performed by a rearrangement unit;

FIG. 16 illustrates a process performed by a modified rearrangement unit;

FIG. 17 illustrates an overall configuration of a second embodiment;

FIG. 18 illustrates a process performed by a file and object management unit according to the second embodiment; and

FIG. 19 illustrates a computer architecture for various servers.

### DESCRIPTION OF THE PREFERRED EMBODIMENTS

Hereinafter, embodiments of the present disclosure will be described with reference to the drawings. Note that the embodiments described below do not limit the disclosure according to the claims, and all of the elements and combinations thereof described in the embodiments are not necessarily essential for the solution of the disclosure.

Each of the systems, devices, or functional units of the present disclosure may be integrated into a single piece of hardware, or may be divided into a plurality of parts that play their roles in cooperation with each other. Some of the systems, devices, or functional units may be integrated in hardware.

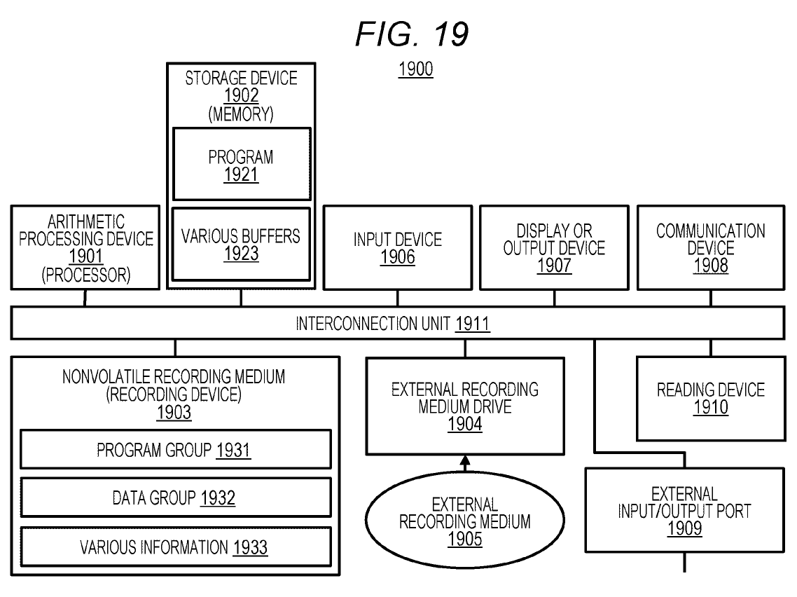

Each of the systems, devices, or functional units may be realized by causing a computer to execute a program (as illustrated in FIG. 19). Some of the functions of the systems, devices, or functional units may be realized by hardware (e.g., hardwired logic or field programmable gate array (FPGA)), and the other functions may be realized by executing a program. All of the functions of each of the systems, devices, or functional units may be realized in hardware. Each of the systems, devices, or functional units of the present disclosure may be virtually implemented. For example, a virtual computer or a virtual container approach may be used.

The program is not limited to any particular type or form of program. In addition, the program may be initially recorded in a compressed format.

In a case where a system, a device, a functional unit, or some of the functions of the functional unit are realized by causing a computer to execute a program, the system, the device, the functional unit, or some of the functions of the functional unit to be realized do not need to be realized at all times. That is, it is sufficient that the system, the device, the functional unit, or some of the functions of the functional unit are realized at a timing when the processing provided by the system, the device, the functional unit, or some of the functions of the functional unit is required.

Those using the same reference number in a plurality of drawings are similar to each other. In a drawing illustrating a flowchart, rectangular boxes indicate processing steps, and hexagonal boxes indicate conditional branching steps. In a drawing illustrating a flowchart, “step” is abbreviated as “S”. In addition, in a drawing illustrating a flowchart, portions circled with the same number are linked in terms of control.

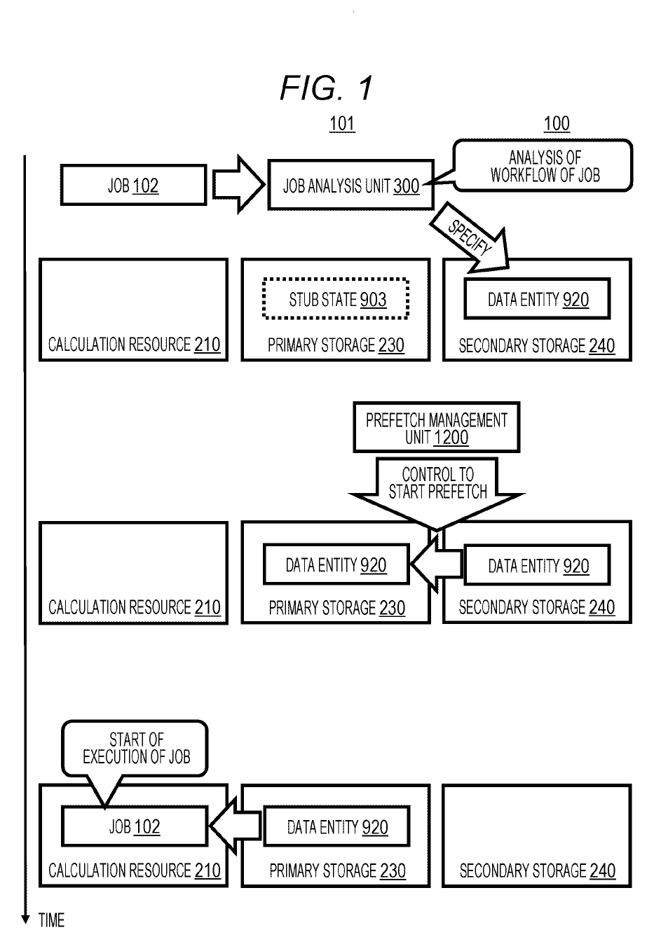

### 1. Basic Functional Configurations (FIG. 1)

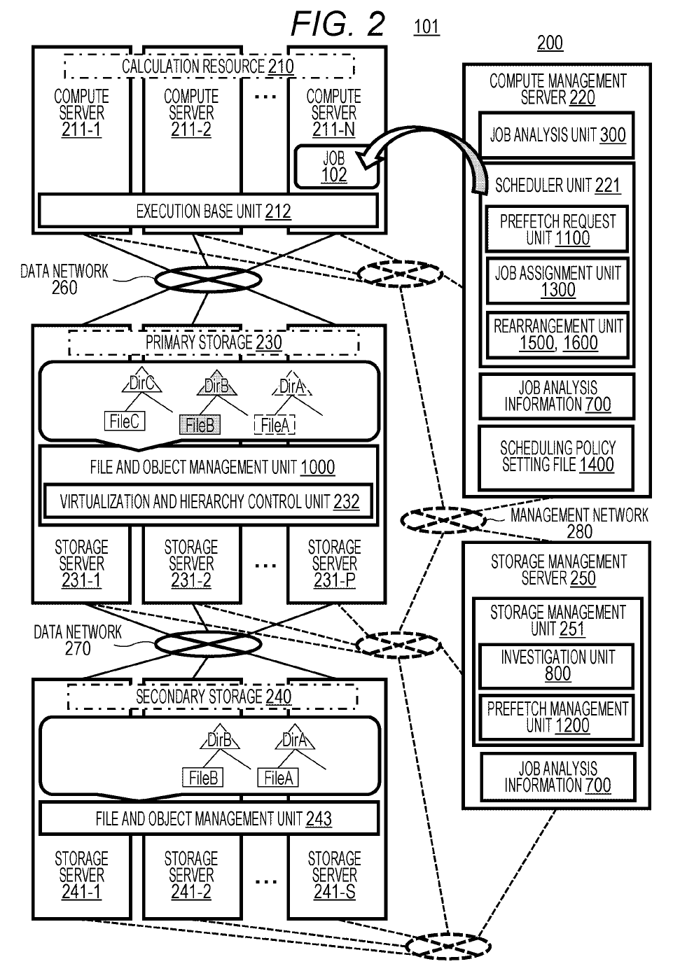

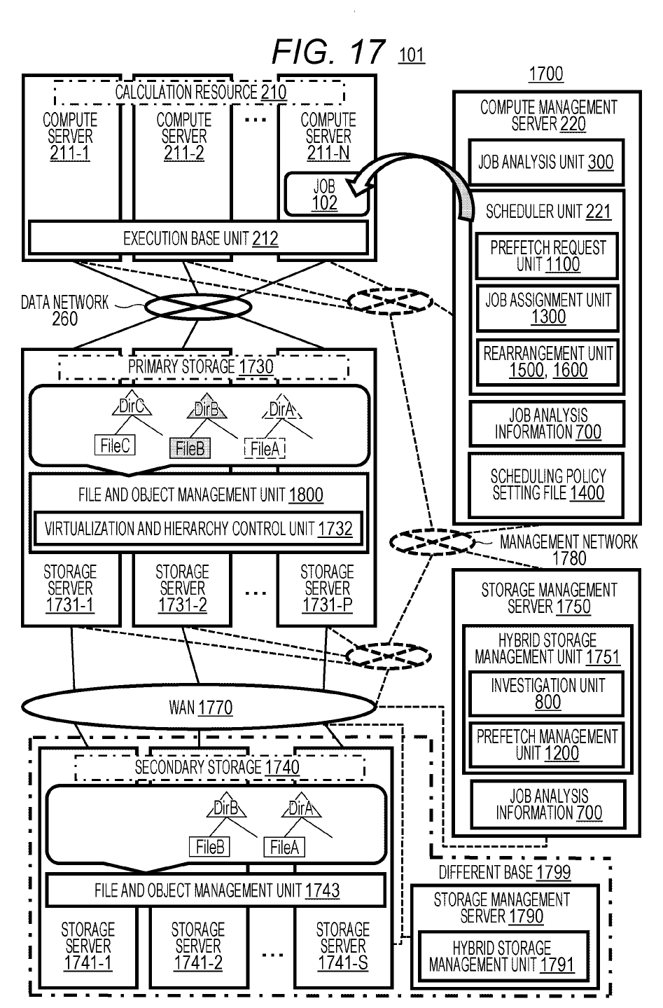

FIG. 1 illustrates basic functional configurations 100 (and information to be handled) of a management system 101 according to an embodiment of the present disclosure. Note that not all of the functional configurations illustrated in FIG. 1 are essential. In addition, the presence of functional configurations other than the functional configurations illustrated in FIG. 1 is not precluded. In FIG. 1 (FIGS. 2 and 17), a solid-line rectangle with “unit” attached to its term indicates a functional unit.

In addition, FIG. 1 includes an upper part, a middle part, and a lower part, and as time passes, the status changes from that illustrated in the upper part of FIG. 1 to that illustrated in the middle part of FIG. 1, and then to that illustrated in the lower part of FIG. 1.

The management system 101 is for managing a calculation resource 210 and storages (a primary storage 230 and a secondary storage 240). As illustrated in FIG. 1, the management system 101 includes a job analysis unit 300 and a prefetch management unit 1200.

The upper part of FIG. 1 illustrates a status at a time before the calculation resource 210 starts executing a job 102.

In the status illustrated in the upper part of FIG. 1, the job analysis unit 300 specifies data to be read when the calculation resource 210 executes the job 102. The job analysis unit 300 may specify data to be read when the calculation resource 210 executes the job 102 by analyzing a workflow of the job 102. The specified data entity 920 may exist in the primary storage 230 having relatively high performance of access from the calculation resource 210 but not exist in the secondary storage 240 having relatively low performance of access from the calculation resource 210, may exist in both the primary storage 230 and the secondary storage 240, or may exist in the secondary storage 240 but not exist in the primary storage 230. In the upper part of FIG. 1, it is illustrated that the specified data entity 920 exists in the secondary storage 240 but does not exist in the primary storage 230. When the data entity 920 exists in the secondary storage 240 but does not exist in the primary storage 230, and the primary storage 230 (or the calculation resource 210) holds management information for the data, it is said that the data is in a stub state 903.

The middle part of FIG. 1 illustrates a status at a later time than the upper part of FIG. 1 and before the calculation resource 210 starts executing the job 102.

In the status illustrated in the middle part of FIG. 1, the prefetch management unit 1200 performs control to start prefetch from the secondary storage 240 to the primary storage 230 for data of which the data entity 920 does not exist in the primary storage 230 and the data entity 920 exists in the secondary storage 240, among the data specified by the job analysis unit 300 for the job 102. In a case where the data entity 920 exists in the secondary storage 240 but does not exist in the primary storage 230 as illustrated in the upper part of FIG. 1, the prefetch management unit 1200 performs control to start transferring (prefetching) the data entity 920 from the secondary storage 240 to the primary storage 230.

The lower part of FIG. 1 illustrates a status at a later time than the middle part of FIG. 1 and after the calculation resource 210 has started executing the job 102.

As illustrated in the middle part of FIG. 1, before the calculation resource 210 starts executing the job 102, prefetch is started for the data entity 920 to be read by the calculation resource 210 when the job 102 is executed. Therefore, there is a high possibility that the data entity 920 is held in the primary storage 230 at a timing when the calculation resource 210 executes the job 102 and actually attempts to read the data as illustrated in the lower part of FIG. 1.

At least as compared with starting prefetch of the data entity 920 to be read for executing the job 102 when the calculation resource 210 is executing the job 102, performing a series of processes illustrated in FIG. 1 increases the possibility that the data entity 920 may exist in the primary storage 230 at the timing when the calculation resource 210 attempts to read the data entity 920 from the primary storage 230.

Although only one job 102 is illustrated in FIG. 1, the management system 101 may handle a plurality of jobs 102 simultaneously in reality. In this case, the management system 101 performs the series of processes illustrated in FIG. 1 for each of the jobs 102.

Since the management system 101 according to the embodiment of the present disclosure has the functional configurations as described above, it is possible to provide the above-described [Effects of the Invention] (the effects described in paragraphs[0010] and [0011]).

### 2. Overall Configurations, Functional Configurations, Information, and Processes of Individual Embodiments

As embodiments of the present disclosure, a first embodiment in which the calculation resource 210, the primary storage 230, and the secondary storage 240 exist in the same base, and a second embodiment in which the calculation resource 210 and the primary storage 230 exist in the same base while the secondary storage 240 exists in a different base (different base 1799) will be described below.

### 2-1. First Embodiment

In the first embodiment described below, it is assumed that the calculation resource 210, the primary storage 230, and the secondary storage 240 exist in the same base. However, the present disclosure is not limited to the case where the calculation resource 210, the primary storage 230, and the secondary storage 240 exist in the same base, by appropriately adjusting how the data read when the calculation resource 210 executes the job 102 is managed in a data space or a file system that can be recognized by the calculation resource 210. (Among them, the case where the secondary storage 240 exists in the different base 1799 can be said to be the second embodiment to be described later.)

### 2-1-1. Overall Configuration of First Embodiment (FIG. 2)

FIG. 2 illustrates an overall configuration 200 of the first embodiment of the present disclosure. Note that not all the functional configurations (and information to be handled) illustrated in FIG. 2 are essential. In addition, the presence of functional configurations other than the functional configurations (and information to be handled) illustrated in FIG. 2 is not precluded.

In this section, an outline of each of the configurations illustrated in FIG. 2 will be described. Detailed processes and information will be described in the section “2-1-3. Functional Configurations, Processes, and Information in First Embodiment” later.

In the first embodiment of the present disclosure, the management system 101 (the management system 101 may be what is referred to as an analysis-based management system) may include a calculation resource 210, a primary storage 230, a secondary storage 240, a compute management server 220, and a storage management server 250. The calculation resource 210 may be formed of one or a plurality of (N in FIG. 1) compute servers 211. The primary storage 230 may include one or a plurality of (P in FIG. 1) storage servers 231. The secondary storage 240 may include one or a plurality of (S in FIG. 1) storage servers 241.

Each of the above-described various servers may be realized by a computer architecture described below in the section “2-1-2. Computer Architecture for Realizing First Embodiment of Present Disclosure” and illustrated in FIG. 19. Depending on the type (role) of server, the performance or capacity of each component illustrated in FIG. 19 may be determined.

Each of the compute servers 211 forming the calculation resource 210 may include a GPU. The compute servers 211 may realize an execution base unit 212 as a functional unit in cooperation with each other by each executing a program for realizing the execution base. The execution base unit 212 may be for causing a container, which is a virtual calculation resource, to execute the job 102 assigned to one of the compute servers 211 by a scheduler unit 221, which is a functional unit of the compute management server 220. Alternatively, the execution base unit 212 may manage a calculation resource other than the container.

Note that any process may be performed by the job 102 here. For example, the job 102 may be for performing a process related to a model or data related to artificial intelligence (AI). Furthermore, for example, in order to train a model for realizing artificial intelligence (AI), the job 102 may perform model parameter optimization processing (big data analysis processing and model training processing) using learning data including big data or the like, or perform preprocessing on the learning data before the optimization processing (analysis processing and model training processing). In this case, the job 102 may be referred to as an analysis job. Furthermore, the job 102 may be for performing estimation or inference using a trained (learned) model for realizing artificial intelligence (AI). In this case, the job 102 may be referred to as an inference job.

Since the management system 101 handles the analysis job or the inference job related to artificial intelligence (AI) as described above, the time required for performing the analysis processing or the inference processing related to artificial intelligence (AI) can be shortened.

The storage servers 231 forming the primary storage 230 may realize a file and object management unit 1000 as a functional unit in cooperation with each other by each executing a program for realizing file and object management. In addition, the storage servers 241 forming the secondary storage 240 may realize a file and object management unit 243 as a functional unit in cooperation with each other by each executing a program for realizing file and object management. Here, the program for realizing file and object management may be common in terms of program code between the primary storage 230 and the secondary storage 240, or there may be differences. Each of the file and object management unit 1000 in the primary storage 230 and the file and object management unit 243 in the secondary storage 240 may provide a function corresponding to a role to be played as a file and object management unit for the data (file).

The file and object management unit 1000 in the primary storage 230 and the file and object management unit 243 in the secondary storage 240 may present a file system for managing data (file) to the compute servers 211 forming the calculation resource 210 in cooperation with each other. The file and object management unit 1000 in the primary storage 230 may actively determine the processing content for managing the file system, and the file and object management unit 243 in the secondary storage 240 may passively operate according to the determination made by the primary storage 230.

The presented file system may be any type of file system. For example, as illustrated in FIG. 2, a file path (including a directory (Dir)) of a file corresponding to data may be specified, thereby enabling access to the file. By presenting the file system, virtualization and hierarchical control of data and files to be stored are realized in a recording medium of each of the storage servers 231 and a recording medium of each of the storage servers 241. In order to illustrate this, FIG. 2 illustrates a virtualization and hierarchy control unit 232 as a functional unit in the file and object management unit 1000.

In a case where the primary storage 230 and the secondary storage 240 are provided in the same base, the recording medium included in the storage server 231 forming the primary storage 230 may be a recording medium (e.g., a solid state drive (SSD)) having relatively high read/write performance, and the recording medium included in the storage server 241 forming the secondary storage 240 may be a recording medium (e.g., a hard disk drive (HHD)) having relatively low read/write performance.

In this way, the primary storage 230 and the secondary storage 240 can present a recording area having a large capacity with high-speed read/write performance to the compute server 211 while keeping costs down.

The primary storage 230 and the secondary storage 240 may provide any sizes of areas for storing data (file), but for example, the size of the storage area in the primary storage 230 may be about 1 petabyte, and the size of the storage area in the secondary storage 240 may be about 5 petabytes.

In addition, both the recording medium included in the storage server 231 forming the primary storage 230 and the recording medium included in the storage server 241 forming the secondary storage 240 may be file storages, object storages, or file object storages, or may be other types of storages. Here, the file storage is a storage that enables access to an access entity using a file path. In addition, the object storage is a storage that acts as a storage having a recording area in bucket units, which is treated as a flat space for the purposes of management for an access entity. The file object storage is a storage that can act as either a file storage or an object storage.

For example, each of the storage servers 231 forming the primary storage 230 may be treated as having a file storage, and the storage servers 231 forming the primary storage 230 may collectively present a high-speed distributed file system to each of the compute servers 211 forming the calculation resource 210. On the other hand, the recording medium included in the storage server 241 forming the secondary storage 240 may be treated as an object storage serving as a backup destination in the hierarchical control. With such a storage configuration, it is possible to implement a hierarchically structured or virtualized storage while providing a file system that can be accessed by a file path to the compute server 211.

In addition, for example, the primary storage 230 and the secondary storage 240 may perform hierarchical control of a data lake.

The compute management server 220 is mainly for controlling each of the compute servers 211 forming the calculation resources 210. As illustrated in FIG. 2, the compute management server 220 includes a job analysis unit 300 and a scheduler unit 221 as functional units. The scheduler unit 221 includes a prefetch request unit 1100, a job assignment unit 1300, and a rearrangement unit 1500 (or 1600) as internal functional units. The compute management server 220 includes job analysis information 700 and a scheduling policy setting file 1400 as information to be handled.

The functional units and the information of the compute management server 220 will be described in detail later in the section “2-1-3. Functional Configurations, Processes, and Information in First Embodiment”.

Note that the job analysis unit 300 and the scheduler unit 221 in the compute management server 220 may be collectively referred to as a compute management unit.

In addition, the job analysis unit 300, the prefetch request unit 1100, the job assignment unit 1300, the rearrangement unit 1500 (or 1600), and the scheduler unit 221 illustrated in FIG. 2 may have any inclusion relationship. For example, the scheduler unit 221 may also include the job analysis unit 300. Alternatively, the scheduler unit 221 may not exist, and the job analysis unit 300, the prefetch request unit 1100, the job assignment unit 1300, and the rearrangement unit 1500 (or 1600) may exist as separate functional units.

The storage management server 250 is mainly for controlling each of the storage servers 231 forming the primary storage 230 and each of the storage servers 241 forming the secondary storage 240. As illustrated in FIG. 2, the storage management server 250 includes a storage management unit 251 as a functional unit. The storage management unit 251 includes an investigation unit 800 and a prefetch management unit 1200 as internal functional units. The storage management server 250 includes job analysis information 700 as information to be handled.

The functional units and the information in the storage management server 250 will be described in detail later in the section “2-1-3. Functional Configurations, Processes, and Information in First Embodiment”.

A data network 260 exists for mutual communication between each of the compute servers 211 forming the calculation resource 210 and each of the storage servers 231 forming the primary storage 230. In addition, a data network 270 exists for mutual communication between each of the storage servers 231 forming the primary storage 230 and each of the storage servers 241 forming the secondary storage 240. Furthermore, a management network 280 exists to transmit and receive information for control between the various servers illustrated in FIG. 2.

In a case where the calculation resource 210, the primary storage 230, and the secondary storage 240 exist in the same base, the data network 260, the data network 270, and the management network 280 may be so-called intranet. For example, the data network 260 may be compliant with InfiniBand, and the data network 270 may be compliant with Ethernet, but they are not limited thereto.

In addition, in a case where the calculation resource 210, the primary storage 230, and the secondary storage 240 exist in the same base, the data network 260 may have a faster communication speed than the data network 270. For example, the data network 260 may have a communication speed of about several hundred gigabits per second, and the data network 270 may have a communication speed of about ten gigabits per second to about one hundred gigabits per second. Even in such a case, the embodiment of the present disclosure can reduce the possibility that an input/output bottleneck occurs.

Some or all of the data network 260, the data network 270, and the management network 280 may be integrated.

### 2-1-2. Computer Architecture for Realizing Various Servers (FIG. 19)

FIG. 19 illustrates a computer architecture 1900 for realizing various servers constituting the management system 101 according to an embodiment (the first embodiment or a second embodiment to be described later) of the present disclosure. The computer architecture 1900 illustrated in FIG. 19 may be referred to as an information processing apparatus or an information processing system. (In addition, the computer architecture 1900, which is an information processing apparatus or an information processing system, may be understood to execute a method.)

In order to realize various servers constituting the management system 101 according to an embodiment of the present disclosure, some or all of an arithmetic processing device 1901, a storage device 1902, a nonvolatile recording medium (recording device) 1903, an external recording medium drive 1904, an input device 1906, a display or output device 1907, a communication device 1908, an external input/output port 1909, and a reading device 1910 may be interconnected by an interconnection unit 1911. (Note that part or all of the interconnection unit 1911 may be a network. In that case, the various servers are realized by a plurality of devices via the network.)

The arithmetic processing device 1901 may be, for example, a processor. Examples of the processor include a CPU, an MPU, or a GPU. Alternatively, the processor referred to herein may be another semiconductor device as long as it is an entity that executes predetermined processing. Furthermore, the arithmetic processing device 1901 may be one or more (micro) processors.

The storage device 1902 may be, for example, a memory. The nonvolatile recording medium (recording device) 1903 may be, for example, a nonvolatile memory (e.g., a flash memory) or a nonvolatile disk device. The external recording medium drive 1904 may be, for example, a disk drive. The input device 1906 may be, for example, a mouse, a keyboard, or the like. The display or output device 1907 may be, for example, a display, a printer, or a speaker. The communication device 1908 may be, for example, a communication device for wired communication or a communication device for wireless communication. The communication device 1908 may be a network interface device (NIC). The interconnection unit 1911 may be, for example, a bus or a crossbar switch. (As described above, part or all of the interconnection unit 1911 may be a network.)

Various programs included in a program group 1931, various data groups included in a data group 1932, or information included in the various information 1933 may be recorded in the nonvolatile recording medium (recording device) 1903.

The program group 1931 may include various programs for realizing each of the functional units indicated as “units” in the functional configuration diagrams of FIGS. 1, 2, and 17. Some of the above-described programs may be integrated into one program. Any of the above-described programs may be divided into a plurality of programs.

The data group 1932 may include information (data and the like) handled by the functional units described above. For example, the data group 1932 may include information constituting each of the information groups or the data groups illustrated in the functional configuration diagrams or the overall configuration diagrams of FIGS. 1, 2, and 17. (Some or all of the information included in the information group or the data group may be stored in the storage device 1902 (memory).)

Alternatively, some or all of the various programs included in the program group 1931, the various information groups or data groups included in the data group 1932, or the information included in the various information 1933 may be acquired from the outside of the configuration illustrated in FIG. 19.

The external recording medium drive 1904 can connect an external recording medium 1905. The external recording medium 1905 may be, for example, a portable recording disk, a nonvolatile memory (e.g., a flash memory), or the like. Note that the various programs included in the program group 1931, the various information groups or data groups included in the data group 1932, or information similar to the information included in the various information 1933 may be transferred from the external recording medium 1905 and stored in the nonvolatile recording medium (recording device) 1903 or the storage device 1902.

The various programs included in the program group 1931, the various information groups or data groups included in the data group 1932, or the information included in the various information 1933 may be brought via the communication device 1908, the external input/output port 1909, the input device 1906, and the reading device 1910, and recorded or stored in the nonvolatile recording medium (recording device) 1903 or the storage device 1902.

In order for the architecture of FIG. 19 to function as the management system 101, each functional unit in the management system 101, or a part of each functional unit (execute one or a series of processes (steps)), various programs included in the program group 1931 may be loaded into the storage device 1902 (for example, from the nonvolatile recording medium (recording device) 1903). The program after being loaded is denoted by 1921 in FIG. 19. Then, the arithmetic processing device 1901 may execute the program 1921 (using the various information groups or data groups included in the data group 1932 or the information included in the various information 1933, which exists in the nonvolatile recording medium (recording device) 1903 or the like, as well, as necessary). By executing the program 1921, the functions of the management system 101, each functional unit in the management system 101, or a part of each functional unit are realized (one or a series of processes (steps) are executed). At this time, various buffers 1923 temporarily formed in the storage device 1902 may also be appropriately used.

### 2-1-3. Functional Configurations, Processes, and Information in First Embodiment

Hereinafter, functional configurations, processes, and information of the management system 101 according to the first embodiment will be described. Note that not all the functional configurations (and information to be handled) to be described below are essential. In addition, the presence of functional configurations other than the functional configurations (and information to be handled) to be described below is not precluded.

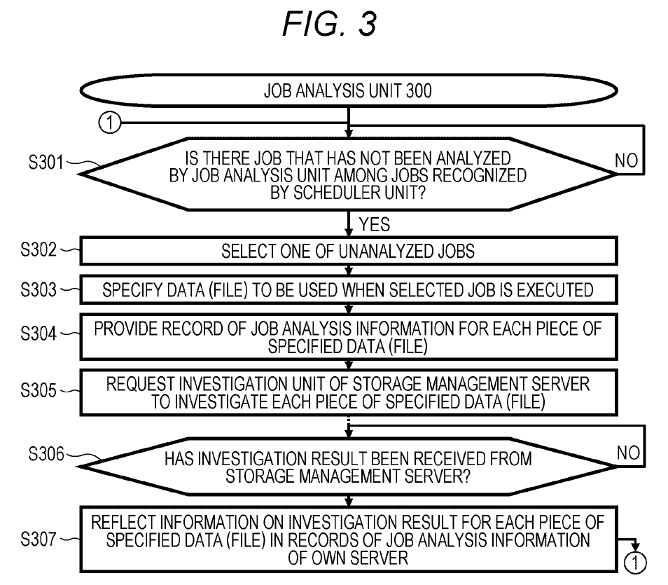

### 2-1-3-1. Job Analysis Unit and Investigation Unit (FIGS. 3 to 10)

In this section, a functional configuration (process) realized by the job analysis unit 300, which is a functional unit realized by the compute management server 220, the investigation unit 800, which is a functional unit realized by the storage management server 250, and the file and object management unit 1000, which is a functional unit realized by the primary storage 230, in cooperation will be described. Furthermore, information used in the functional configuration (process) will be described.

According to the functional configuration, process, and information to be described below, it is possible to analyze a job before starting execution of the job, and specify data to be read into the calculation resource (compute server) when the job is executed.

As will be described below, in a case where data to be read when a job is executed is specified by analyzing a workflow of the job, the data can be specified more accurately or the data can be specified in a larger amount than in a case where the data is specified based on past access patterns (based on historical analysis).

In addition, it is possible to grasp the status for each piece of the data read into the calculation resource (compute server) when the job is executed. Here, the grasped status may include a data (file) state indicating whether the data entity exists in the primary storage or the secondary storage, and a stub file size, which is a data size of a portion of the data of which the data entity does not exist in the primary storage and the data entity exists in the secondary storage.

As a result, more accurate information is collected as information used in the control for prefetch of data to be described later in the section “2-1-3-2. Prefetch Request Unit and Prefetch Management Unit” and in the control for job assignment to the calculation resource (compute server) to be described later in the section “2-1-3-3. Job Assignment Unit and Rearrangement Unit”.

FIG. 3 illustrates a flowchart of a process of the job analysis unit 300, which is a functional unit realized by the compute management server 220. Each step illustrated in FIG. 3 may constitute a “job analysis step”.

In step 301 of FIG. 3, the job analysis unit 300 determines whether there is a job 102 that has not yet been analyzed by the job analysis unit 300 (unanalyzed job) among the jobs 102 recognized by the scheduler unit 221. Here, the job 102 recognized by the scheduler unit 221 is a job 102 scheduled to be assigned to one of the compute servers 211 forming the calculation resource 210 by the scheduler unit 221. In addition, the job 102 that has not yet been analyzed by the job analysis unit 300 is a job 102 for which data (file) to be read when the job 102 is executed has not yet been specified and the status of the data (file) has not yet been investigated. When the determination result in step 301 is positive, the control proceeds to step 302. When the determination result in step 301 is negative, step 301 is repeated.

In step 302 of FIG. 3, the job analysis unit 300 selects one of the unanalyzed jobs.

In step 303 of FIG. 3, for the job 102 selected in the most recent step 302, the job analysis unit 300 specifies data (file) to be read when one of the compute servers 211 forming the calculation resource executes the job 102. The data may be in the form of a file.

When the job analysis unit 300 specifies data (file) to be read when one of the compute servers 211 executes the job 102, the job analysis unit 300 may specify the data (file) by analyzing the workflow of the job 102.

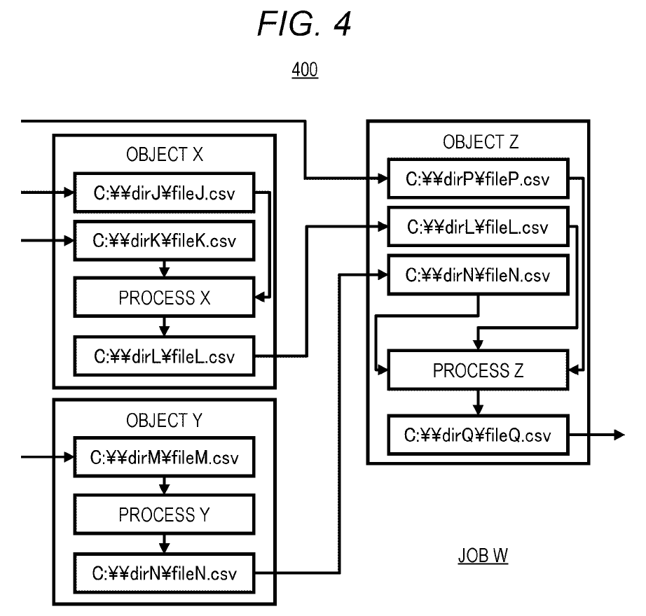

FIG. 4 illustrates an example of workflow 400 of the job 102 (referred to as a job W in FIGS. 4, 5, and 6). Here, FIG. 4 illustrates a case where the primary storage 230 is a file storage in which a file can be accessed, and an access path to data is a file path 705. In a case where the primary storage 230 is an object storage in which data can be accessed by a URL beginning with http or https, an access path to the data may be the URL beginning with http or https.

FIG. 4 illustrates an aspect of a user interface in low-code development.

In the example of FIG. 4, the processes executed in the job W include a process X, a process Y, and a process Z.

The process X is a process in which data (file) of which the file path 705 is “C:\\dirJ\fileJ.csv” (this file path 705 means a csv file called fileJ.csv under a drive called dirJ under the root of the C drive, and the same applies hereinafter) and data (file) of which the file path 705 is “C:\\dirK\fileK.csv” are input, and an output, which is a result of the process X, is data (file) of which the file path 705 is “C:\\dirL\fileL.csv”.

The process Y is a process in which data (file) of which the file path 705 is “C:\\dirM\fileM.csv” is input, and an output, which is a result of the process Y, is data (file) of which the file path 705 is “C:\\dirN\fileN.csv”.

The process Z is a process in which data (file) of which the file path 705 is “C:\\dirP\fileP.csv”, data (file) of which the file path 705 is “C:\\dirL\fileL.csv”, which is an output of the process X, and data (file) of which the file path 705 is “C:\\dirN\fileN.csv”, which is an output of the process Y, are input, and an output, which is a result of the process Z, is data (file) of which the file path 705 is “C:\\dirQ\fileQ.csv”.

In the example of FIG. 4, the data (file) to be read when the calculation resource 210 (compute server) executes the job W is data (file) of which the file path 705 is “C:\\dirJ\fileJ.csv”, data (file) of which the file path 705 is “C:\\dirK\fileK.csv”, data (file) of which the file path 705 is “C:\\dirM\fileM.csv”, and data (file) of which the file path 705 is “C:\\dirP\fileP.csv”.

One or a plurality of objects (an object X, an object Y, and an object Z in FIG. 4) may be used in information describing the example of workflow 400 of the job W illustrated in FIG. 4.

In the example of FIG. 4, the object X may include information specifying the type of the process X, information specifying the file path 705 of data (file) that is an input for the process X, and information specifying the file path 705 of data (file) that is an output, which is a result of the process X. Similarly, the object Y may include information specifying the type of the process Y, information specifying the file path 705 of data (file) that is an input for the process Y, and information specifying the file path 705 of data (file) that is an output, which is a result of the process Y. Similarly, the object Z may include information specifying the type of the process Z, information specifying the file path 705 of data (file) that is an input for the process Z, and information specifying the file path 705 of data (file) that is an output, which is a result of the process Z.

In step 302, the job analysis unit 300 may specify data (file) to be read when one of the compute servers 211 forming the calculation resource executes the job 102, by grasping information included in the object in the information describing the workflow of the job as illustrated in FIG. 4.

In a case where the job analysis unit 300 specifies data (file) to be read when one of the compute servers 211 forming the calculation resource executes the job 102 by analyzing the information describing the workflow of the job, the job analysis unit 300 can grasp the workflow of the job 102 in detail and accurately grasp the data (file).

Alternatively, the job analysis unit 300 may specify data to be read when one of the compute servers 211 forming the calculation resource executes the job 102, by referring to an argument of a command for calling the job.

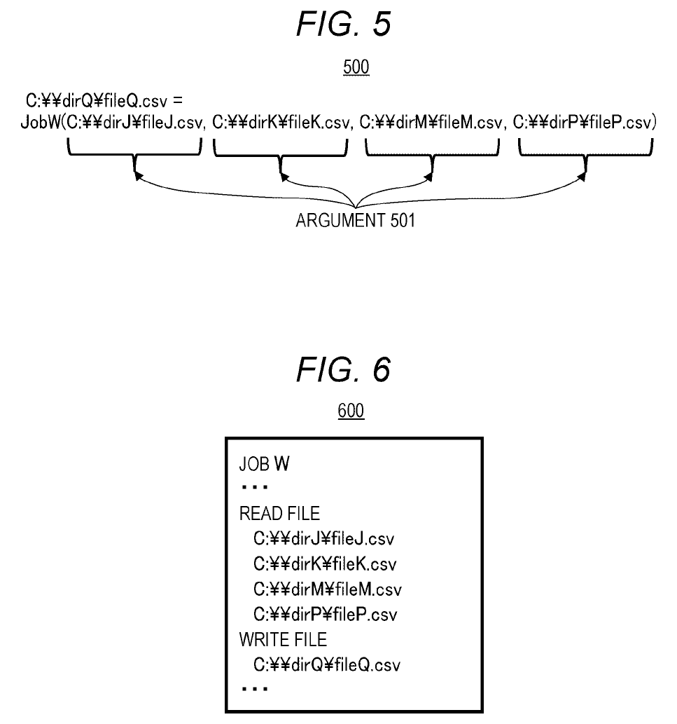

FIG. 5 illustrates an example of command 500 for calling the job 102. Here, FIG. 5 illustrates a case where the primary storage 230 is a file storage in which a file can be accessed, and an access path to data is a file path 705. In a case where the primary storage 230 is an object storage in which data can be accessed by a URL beginning with http or https, an access path to the data may be the URL beginning with http or https.

FIG. 5 illustrates an example of command for calling the job W having the workflow illustrated in FIG. 4. As illustrated in FIG. 5, the command for calling the job W includes “JobW” indicating the term for the job W itself. In addition, the command may include, as arguments, “C:\\dirJ\fileJ.csv”, “C:\\dirK\fileK.csv”, “C:\\dirM\fileM.csv”, and “C:\\dirP\fileP.csv”, which are information specifying the file path 705 of data (file) to be read when the job W is executed. Further, the command may include “C:\\dirQ\fileQ.csv”, which is information specifying the file path 705 of data (file) that is an output indicating a result of processing the job W, as a return value.

In a case where the job analysis unit 300 specifies data (file) to be read when one of the compute servers 211 forming the calculation resource executes the job 102 by referring to the argument of the command for calling the job, the job analysis unit 300 can roughly grasp the data (file) without grasping the inside of the workflow in detail.

Alternatively, the job analysis unit 300 may acquire specific information of data (file) to be read when one of the compute servers 211 forming the calculation resource executes the job 102 by referring to a setting file for the job 102.

FIG. 6 illustrates an example of setting file 600 for the job 102. The setting file is a target to be read by the compute server 211 forming the calculation resource 210 when the job 102 is executed. Here, FIG. 6 illustrates a case where the primary storage 230 is a file storage in which a file can be accessed, and an access path to data is a file path 705. In a case where the primary storage 230 is an object storage in which data can be accessed by a URL beginning with http or https, an access path to the data may be the URL beginning with http or https.

FIG. 6 illustrates an example of setting file for the job W having the workflow illustrated in FIG. 4. The setting file for the job W may include “job W” indicating the term for the job W itself, “C:\\dirJ\fileJ.csv”, “C:\\dirK\fileK.csv”, “C:\\dirM\fileM.csv”, and “C:\\dirP\fileP.csv”, which are information specifying the file path 705 of data (file) to be read when the job W is executed, and “C:\\dirQ\fileQ.csv”, which is information specifying the file path 705 of data (file) that is an output indicating a result of processing the job W.

The job analysis unit 300 specifies data (file) to be read when one of the compute servers 211 forming the calculation resource executes the job 102, by extracting, from the setting file illustrated in FIG. 6, part of the information specifying the file path 705 of data (file) to be read when the job W is executed.

In a case where the job analysis unit 300 specifies data (file) to be read when one of the compute servers 211 forming the calculation resource executes the job 102 by referring to the setting file for the job, the job analysis unit 300 can roughly grasp the data (file) without grasping the inside of the workflow in detail.

In step 304 of FIG. 3, the job analysis unit 300 provides a record in the job analysis information 700 for each piece of the data (file) specified in the most recent step 303.

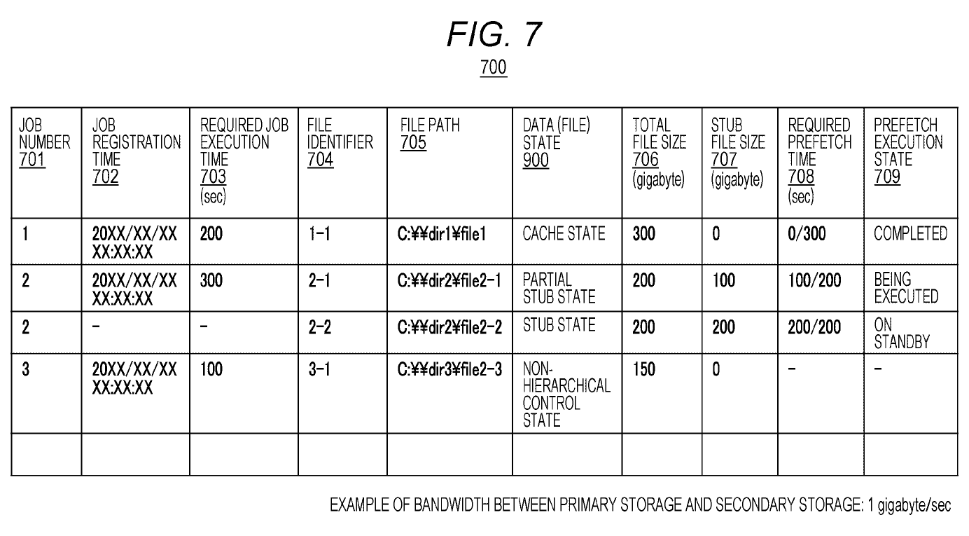

FIG. 7 illustrates the job analysis information 700.

FIG. 7 is shown in a tabular manner. One row in this table corresponds to a record. One record may correspond to one piece of data (file) to be read when one of the compute servers 211 forming the calculation resource executes the job 102. In the example of the job W illustrated in FIGS. 4, 5, and 6 the records for the job analysis information 700 may be provided for each of the data (file) of “C:\\dirJ\fileJ.csv”, the data (file) of “C:\\dirK\fileK.csv”, the data (file) of “C:\\dirM\fileM.csv”, and the data (file) of “C:\\dirP\fileP.csv”.

As illustrated in FIG. 7, each of the records of the job analysis information 700 may include the following items: job number 701, job registration time 702, required job execution time 703, file identifier 704, file path 705, data (file) state 900, total file size 706, stub file size 707, required prefetch time 708, and prefetch execution state 709.

The job number 701 indicates information specifying the job 102 in which data (file) corresponding to records is used. Note that the job number 701 may be a general identifier other than a number.

The job registration time 702 may be a time when the scheduler unit 221 recognizes that the job 102 using the data (file) corresponding to the records is a target to be assigned to one of the compute servers 211 or a time when the records are registered.

The required job execution time 703 indicates an estimated value of time required when the job 102 using the data (file) corresponding to the records is executed by the compute server 211. The required job execution time 703 may be a past performance value of required time or a statistical value thereof, or may be a value derived by a certain model formula.

The file identifier 704 is information for identifying the data (file) corresponding to the records. In a case where a file path 705 to be described later is always set, this file identifier 704 does not need to exist.

The file path 705 is information indicating a location of the data (file) corresponding to the records in a file system managed by the file and object management unit 1000. Here, FIG. 7 illustrates a case where the primary storage 230 is a file storage in which a file can be accessed, and an access path to data is a file path 705. In a case where the primary storage 230 is an object storage in which data can be accessed by a URL beginning with http or https, an access path to the data may be the URL beginning with http or https.

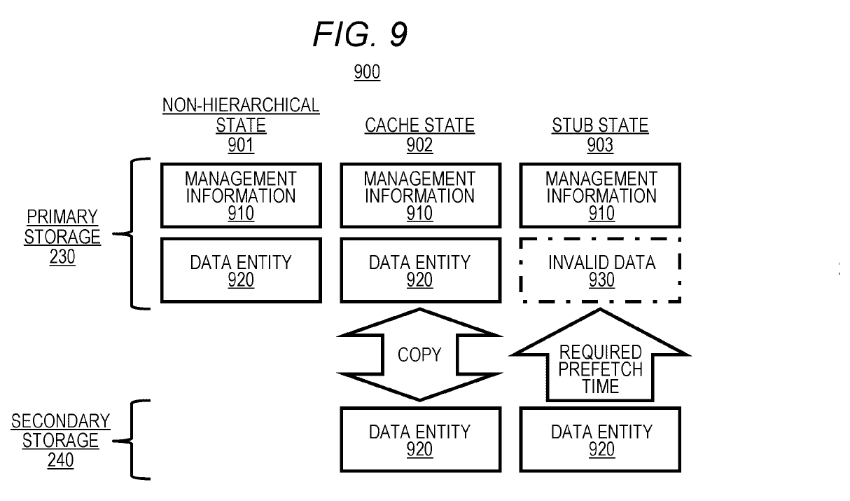

The data (file) state 900 is information indicating whether an entity of the data (file) (data entity 920) corresponding to the records exists in the primary storage 230 or the secondary storage 240. This will be described in detail later with reference to FIG. 9.

The total file size 706 indicates a size of the data (file) corresponding to the records. The total file size 706 indicates an overall size of data (file) regardless of which storage the data entity 920 exists in.

The stub file size 707 indicates a size of data in a non-cache portion of the primary storage 230 in a case where there is no data entity 920 in the primary storage 230 and there is a portion where the data entity 920 exists in the secondary storage 240 for the data (file) corresponding to the records. For example, in an example of data (file) for which the file path 705 is “C:\\dir2\file2-1” in FIG. 7, the stub file size 707 is 100 gigabytes out of the total file size 706 of 200 gigabytes. That is, for 100 gigabytes of data out of 200 gigabytes of data, the data entity 920 is not cached in the primary storage 230, and the data entity 920 exists in the secondary storage 240.

The required prefetch time 708 indicates an estimated value of time required to transfer (prefetch) the data entity 920 indicated by the stub file size 707 from the secondary storage 240 to the primary storage 230. For example, in an example of data (file) for which the file path 705 is “C:\\dir2\file2-1” in FIG. 7, the estimated value of the time required to transfer (prefetch) the data entity 920 having a stub file size 707 of 100 gigabytes is 100 seconds. Note that, in FIG. 7, although “100/200” is shown in the item of the required prefetch time 708, the part “/200” indicates an estimated value of time required for prefetch in a case where the data entity 920 having the total file size 706 is transferred (prefetched). This part “/200” does not need to exist.

The required prefetch time 708 is utilized in any manner. The required prefetch time 708 may be used to control prefetch. For example, the required prefetch time 708 may be used for adjustment between a time at which prefetching of data (file) from the secondary storage 240 to the primary storage 230 is started and a time at which the calculation resource 210 (compute server) uses the prefetched data (file). If the required prefetch time 708 is used in the above-described manner, it is more likely that the calculation resource 210 (compute server) can read data (file) at the time when the calculation resource 210 (compute server) uses the data (file).

The prefetch execution state 709 indicates an execution state of transfer (prefetch) of the data (file) corresponding to the records from the secondary storage 240 to the primary storage 230. If the prefetch execution state 709 is “completed”, this means that the transfer (prefetch) is completed or the transfer (prefetch) is not originally required. If the prefetch execution state 709 is “being executed”, this means that the transfer (prefetch) is being executed. If the prefetch execution state 709 is “on standby”, this means that the required transfer (prefetch) has not been started, or the transfer (prefetch) has been interrupted for some reason.

By providing the job analysis information 700 as illustrated in FIG. 7, it is possible to grasp information specifying each piece of data (file) to be read when the calculation resource (compute server) executes the job 102 and the status of the data (file).

Note that, in step 304 of FIG. 3, at the time when the records of the job analysis information 700 are provided, the items of the data (file) state 900, the total file size 706, the stub file size 707, the required prefetch time 708, and the prefetch execution state 709, among the items of records, are not necessarily set. These items may be set through investigation by the investigation unit 800 and the file and object management unit 1000 to be described later.

In step 305 of FIG. 3, the job analysis unit 300 requests the investigation unit 800, which is a functional unit realized by the storage management server 250, to investigate the status of the data (file) for each piece of the data (file) specified in the most recent step 303.

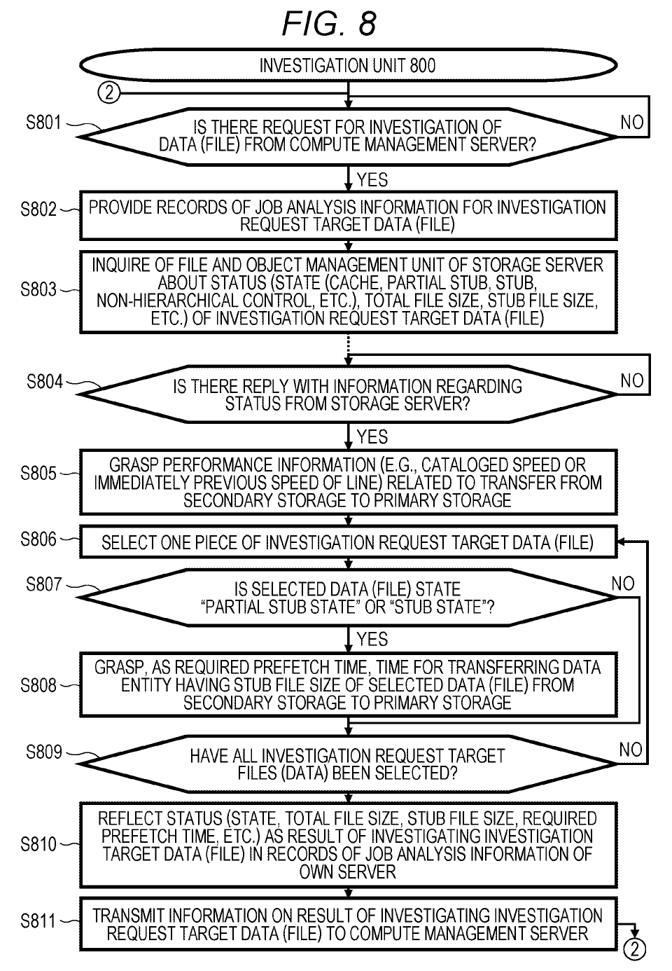

FIG. 8 is a flowchart of a process of the investigation unit 800, which is a functional unit realized by the storage management server 250. Each step illustrated in FIG. 8 may constitute an “investigation step”.

In step 801 of FIG. 8, the investigation unit 800 determines whether there is a request for investigating the status of data (file) from (the job analysis unit 300 of) the compute management server 220. This request is a request made in step 305 of FIG. 3. When the determination result in step 801 is positive, the control proceeds to step 802. When the determination result in step 801 is negative, step 801 is repeated.

In step 802 of FIG. 8, the investigation unit 800 provides records of the job analysis information 700 for data (file) that is a target of the status investigation request. In step 304 of FIG. 3, records of the job analysis information 700 accessed from the compute management server 220 are provided, but in step 802, records of the job analysis information 700 accessed from the storage management server 250 are provided. That is, as for the job analysis information 700, one accessed from the compute management server 220 and one accessed from the storage management server 250 may be provided and controlled so as to hold substantially similar information.

In step 803 of FIG. 8, the investigation unit 800 inquires of the file and object management unit 1000, which is realized by each of the storage servers 231 forming the primary storage 230, about the status of the data (file) that is a target of the status investigation request. The inquired status may include the data (file) state 900, the total file size 706, or the stub file size 707 in the records of the job analysis information 700 of FIG. 7.

FIG. 9 illustrates a data (file) state 900.

In a file system presented to each of the compute servers 211 by the file and object management unit 1000, there may be a non-hierarchical state 901, a cache state 902, and a stub state 903 as a data (file) state 900 of data (file) to be read when the job 102 is executed. In any state, the management information 910 for the data (file) may exist in the primary storage 230, and the management information 910 may be accessible from the file and object management unit 1000.

The non-hierarchical state 901 is a state indicating that the data entity 920 exists only in the primary storage 230. For example, when a data entity 920 created for the first time by the compute server 211 forming the calculation resource 210 is stored in the primary storage 230, the data may be in the non-hierarchical state 901. By using the non-hierarchical state 901, it is possible to eliminate the need to always manage all data (file) hierarchically.

The cache state 902 is a state in which the data entity 920 exists in both the primary storage 230 and the secondary storage 240. In this case, it can be said that one of the data entity 920 in the primary storage 230 and the data entity 920 in the secondary storage 240 is a copy of the other.

For example, by using a time when there is a sufficient communication bandwidth (a communication bandwidth of the data network 270) between the primary storage 230 and the secondary storage 240, for data (file) in the non-hierarchical state 901, the data entity 920 may be transferred (destaged or backed up) from the primary storage 230 to the secondary storage 240, thereby changing the data (file) state to a cache state 902. At this time, the information regarding the directory on the file system can also be transferred (destaged or backed up) from the primary storage 230 to the secondary storage 240. In a case where the secondary storage 240 is an object storage, the information regarding the directory on the file system is also recorded in the recording area in units of buckets.

By using the cache state 902, while the data entity 920 can be accessed from the compute server 211, the data entity 920 can be backed up and can be transitioned to the stub state 903 to be described later at any time.

The stub state 903 is a state in which the data entity 920 does not exist in the primary storage 230 and the data entity 920 exists in the secondary storage 240. Alternatively, the stub state 903 may be a state in which the data entity 920 does not exist in the primary storage 230 but the primary storage 230 is treated as if data (file) exists therein for the purposes of file system management. In the file system presented by the file and object management unit 1000, such data (file) may be referred to as “stub data (stub file)”. Alternatively, invalid data 930 may exist in the primary storage 230. Even in such a case, the management information 910 for data exists in the primary storage 230 and can be accessed from the file and object management unit 1000.

For example, when the data (file) in the cache state 902 has not been accessed from the compute server 211 for a long period of time or when the data (file) in the cache state 902 has been infrequently accessed from the compute server 211, the file and object management unit 1000 may invalidate the data entity 920 in the primary storage 230, making it invalid data 930, to change the data (file) state 900 to the stub state 903.

Alternatively, when a free area in the primary storage 230 falls below a predetermined threshold value, the file and object management unit 1000 may invalidate the data entity 920 in the primary storage 230, making it invalid data 930, to change the data (file) state 900 to the stub state 903.

Although the use of the stub state 903 is not capable of supporting immediate access from the compute server 211 to the data entity 920, it still makes it possible for the compute server 211 to recognize the existence of the data (file).

In order to transition the data (file) state 900 from the stub state 903 to the cache state 902 and enable the compute server 211 to read the data entity 920, it is necessary to transfer (stage or prefetch) the data entity 920 from the secondary storage 240 to the primary storage 230. This transfer time is referred to as a required prefetch time 708.

In some cases, when the file system presented by the file and object management unit 1000 starts managing certain data (file), the data (file) state 900 may be set to the stub state.

The data (file) may include a plurality of portions, and the data (file) state 900 may be set for each portion. For example, a certain portion of one piece of data (file) may be in the cache state 902, and the remaining portion may be in the stub state 903. In this case, the data (file) state as one piece of data (file) may be referred to as a “partial stub state”. For example, the “partial stub state” may appear in a status where a process of transferring (staging or prefetching) data (file) that has been in the stub state 903 from the secondary storage 240 to the primary storage 230 is in progress. The stub file size 707 for the data (file) that is in the “partial stub state” may be defined by a data entity 920 of a portion that is in the stub state 903 in the data (file).

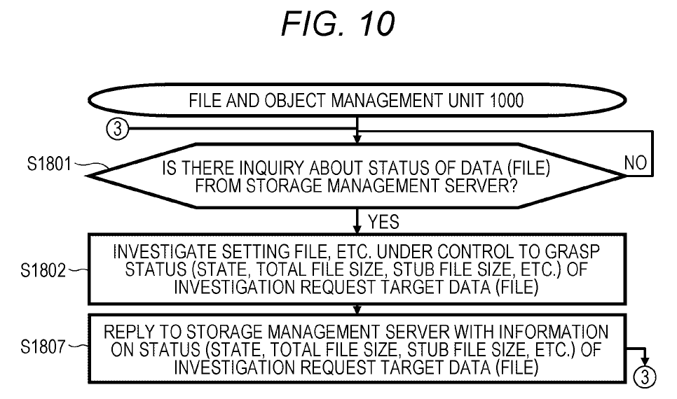

In step 803 of FIG. 8, in response to the inquiry about the status of the data (file) that is a target of the status investigation request from the investigation unit 800 to the file and object management unit 1000, the file and object management unit 1000 recognizes the inquiry in step 1801 of FIG. 10.

FIG. 10 illustrates a flowchart of a process of the file and object management unit 1000, which is a functional unit realized by each of the storage servers 231 forming the primary storage 230. Each step illustrated in FIG. 10 may constitute a “file and object management step”.

In step 1801 of FIG. 10, the file and object management unit 1000 determines whether there is an inquiry about the status of data (file) from (the investigation unit 800 of) the storage management server 250. When an inquiry from the investigation unit 800 occurs in step 803 of FIG. 8, the file and object management unit 1000 recognizes the inquiry in step 1801. When the determination result in step 1801 is positive, the control proceeds to step 1802. When the determination result in step 1801 is negative, step 1801 is repeated.

In step 1802 of FIG. 10, the file and object management unit 1000 grasps the status of data (file) that is a target of the inquiry in step 1801. The file and object management unit 1000 may investigate, for example, the setting file managed by the file and object management unit 1000 in order to grasp the status of the data (file). The status of the data (file) investigated in step 1802 may be, for example, the data (file) state 900, the total file size 706, or the stub file size 707 in FIG. 7. This status may also include the prefetch execution state 709. After step 1802, the control of the file and object management unit 1000 proceeds to step 1807.

In step 1807 of FIG. 10, the file and object management unit 1000 transmits (replies with) the information regarding the status of the data (file) obtained by the investigation in step 1802 to (the investigation unit 800 of) the storage management server 250. After step 1807, the control of the file and object management unit 1000 returns to step 1801.

In response to the transmission of the information regarding the status of the data (file) that is a target of the status investigation request from the file and object management unit 1000 to the investigation unit 800 in step 1807 of FIG. 10, the investigation unit 800 recognizes the reception of the information regarding the status in step 804 of FIG. 8.

In step 804 of FIG. 8, the investigation unit 800, which is a functional unit of the storage management server 250, determines whether the information regarding the status, which is a reply to the inquiry in the most recent step 803, has been received from (the file and object management unit 1000, which is a functional unit realized by) the storage server 231 forming the primary storage 230. When the determination result in step 804 is positive, the control proceeds to step 805. When the determination result in step 804 is negative, step 804 is repeated.

In step 805 of FIG. 8, the investigation unit 800 grasps performance information related to the transfer of the data (file) from the secondary storage 240 to the primary storage 230. The performance information may be, for example, a cataloged transfer speed of a line (data network 270 in FIG. 2 or wide area network (WAN) 1770 in FIG. 17 in the second embodiment to be described below) used for the transfer, or the most recently measured transfer speed of the line. The processing of step 805 does not need to be performed every time the control reaches step 805, and may be performed only once every few times or initially only once.

In step 806 of FIG. 8, the investigation unit 800 selects one piece of the data (file) that was a target of the request for investigation of status in the most recent step 803 and that corresponds to the information regarding the status received in the most recent step 804.

In step 807 of FIG. 8, the investigation unit 800 determines whether the data (file) state 900 of the data (file) selected in the most recent step 806 is a state in which, even for a portion of the data (file), the data entity 920 does not exist in the primary storage 230 and the data entity 920 exists in the secondary storage 240. For example, the investigation unit 800 may determine whether the data (file) state 900 is “partial stub state” or “stub state”. When the determination result in step 807 is positive, the control proceeds to step 808. When the determination result in step 807 is negative, then the control proceeds to step 809 (skipping step 808).

In step 808 of FIG. 8, the investigation unit 800 grasps a stub file size 707, which is a size of the data entity 920 of the portion of the data (file) selected in the most recent step 806, where the data entity 920 does not exist in the primary storage 230 and the data entity 920 exists in the secondary storage 240.

Then, the investigation unit 800 calculates or grasps a required prefetch time 708, which is a time required to transfer (stage or prefetch) the data entity 920 having the stub file size 707 from the secondary storage 240 to the primary storage 230. The investigation unit 800 may set, as the required prefetch time 708, for example, a value obtained by dividing the stub file size 707 by the transfer speed of the line (data network 270 in FIG. 2 or wide area network (WAN) 1770 in FIG. 17 in the second embodiment to be described below) used for the transfer of the data from the secondary storage 240 to the primary storage 230, which is grasped in step 805. After step 808, the control proceeds to step 809.

In step 809 of FIG. 8, the investigation unit 800 determines whether all of the data (file) that was a target of the request for investigation of status in the most recent step 803 and that corresponds to the information regarding the status received in the most recent step 804 has been selected in step 806. When the determination result in step 809 is positive, the control proceeds to step 810. When the determination result in step 809 is negative, the control returns to step 806, and one piece of the data (file) that has not yet been selected is newly selected.

In step 810 of FIG. 8, the investigation unit 800 reflects the information regarding the status received in the most recent step 804 and the required prefetch time 708 calculated or grasped in step 808 in the records of the job analysis information 700 accessible from the storage management server 250.

In step 811 of FIG. 8, the investigation unit 800 transmits the information regarding the status received in the most recent step 804 and the required prefetch time 708 calculated or grasped in step 808 to (the job analysis unit 300 of) the compute management server 220 as information on an investigation result corresponding to the inquiry received in the most recent step 801. After step 811, the control of the investigation unit 800 returns to step 801.

In step 811 in FIG. 8, in response to the transmission of the information on the investigation result regarding the status of the data (file) from the investigation unit 800 to the job analysis unit 300, the job analysis unit 300 recognizes the reception of the information on the investigation result in step 306 in FIG. 3.

In step 306 of FIG. 3, the job analysis unit 300 determines whether information on an investigation result regarding the status of data (file), which is a reply to the request for investigation regarding the status of each piece of data (file) made in the most recent step 305, has been received from (the investigation unit 800 of) the storage management server 250. When the determination result in step 306 is positive, the control proceeds to step 307. When the determination result in step 306 is negative, step 306 is repeated.

In step 307 of FIG. 3, the job analysis unit 300 reflects the information on the investigation result regarding the status of the data (file) received in the most recent step 306 in the records of the job analysis information 700 accessible by the compute management server 220. Through step 810 in FIG. 8 and step 307 in FIG. 3, the two pieces of job analysis information 700 have substantially similar information. After step 307, the control of the job analysis unit 300 returns to step 301.

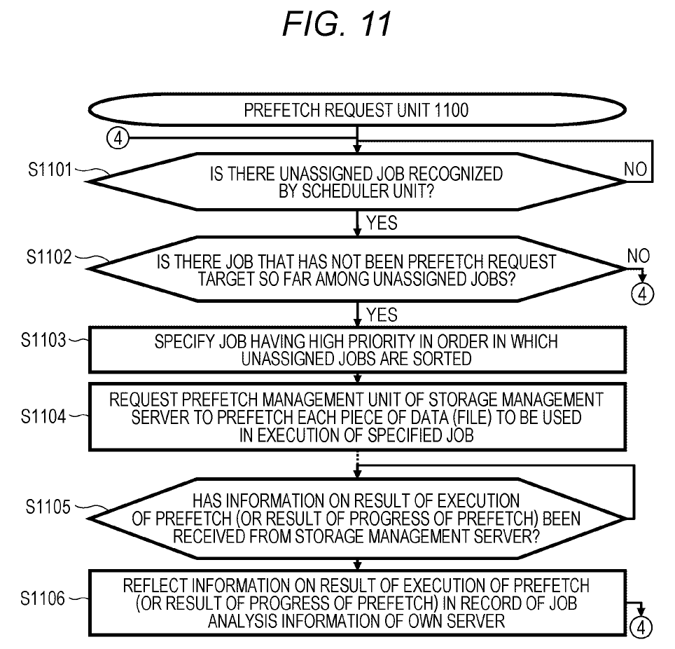

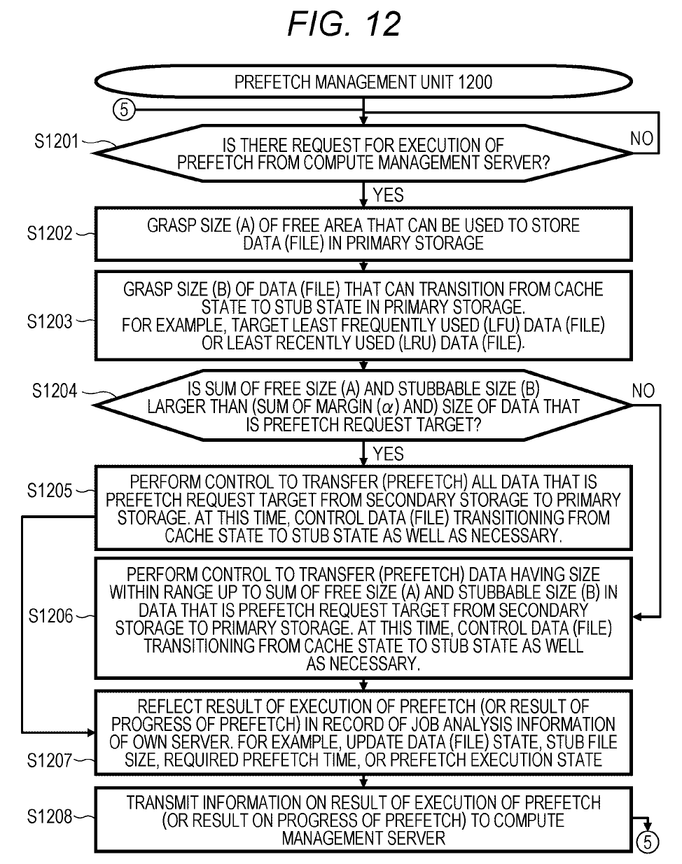

### 2-1-3-2. Prefetch Request Unit and Prefetch Management Unit (FIGS. 11 and 12)

In this section, a functional configuration (process) realized by the prefetch request unit 1100, which is a functional unit realized by the compute management server 220, the prefetch management unit 1200, which is a functional unit realized by the storage management server 250, and the file and object management unit 1000, which is a functional unit realized by the primary storage 230, in cooperation will be described. Furthermore, information used in the functional configuration (process) will be described.

According to the functional configuration, process, and information to be described below, before the execution of the job 102 is started, prefetch from the secondary storage 240 to the primary storage 230 can be started for a portion of the data (file) specified by the job analysis unit 300 for the job 102 where the data entity 920 does not exist in the primary storage 230 and the data entity 920 exists in the secondary storage 240. In this manner, since the prefetching of data (file) is started before the execution of the job 102 is started, it is possible to increase the possibility that the data entity 920 may exist in the primary storage 230 at a timing when the calculation resource 210 (compute server) actually uses the data (file) when executing the job 102, as compared with that in a case where the prefetching is started during the execution of the job 102. That is, it can be expected that the possibility of stand-by that occurs when the calculation resource 210 (compute server) executes the job 102 will decrease, and the stand-by time will be reduced.

FIG. 11 illustrates a flowchart of a process of the prefetch request unit 1100, which is a functional unit realized by the compute management server 220. Each step illustrated in FIG. 11 may constitute a “prefetch request step”.

In step 1101 of FIG. 11, the prefetch request unit 1100 determines whether there is a job 102 that is recognized by the scheduler unit 221 and that has not yet been assigned to any of the compute servers 211 forming the calculation resource 210 (unassigned job). When the determination result in step 1101 is positive, the control proceeds to step 1102. When the determination result in step 1101 is negative, step 1101 is repeated.

In step 1102 of FIG. 11, the prefetch request unit 1100 determines whether there is a job 102 that has not been a prefetch request target so far in step 1104 to be described below among the unassigned jobs recognized in the most recent step 1101. When the determination result in step 1102 is positive, the control proceeds to step 1103. When the determination result in step 1102 is negative, the control of the prefetch request unit 1100 returns to step 1101.

In step 1103 of FIG. 11, the prefetch request unit 1100 specifies one job 102 from among the jobs 102 that have not been prefetch request targets, which were recognized in step 1102. The prefetch request unit 1100 may specify a job 102 having a relatively high priority, for example, in the order in which the unassigned jobs are arranged according to the priority of assignment to the compute server 211. Furthermore, in step 1103, the prefetch request unit 1100 may specify a plurality of jobs 102.

In step 1104 of FIG. 11, the prefetch request unit 1100 requests the prefetch management unit 1200 of the storage management server 250 to execute prefetching for each piece of the data (file) to be read when the job 102 specified in the most recent step 1103 is executed. The prefetching refers to transferring (staging or prefetching) the data entity 920 from the secondary storage 240 to the primary storage 230 for a portion of each piece of the data (file) to be read when the specified job 102 is executed where the data entity 920 does not exist in the primary storage 230 and the data entity 920 exists in the secondary storage 240.

In step 1104 of FIG. 11, in response to the request for executing prefetch from the prefetch request unit 1100 to the prefetch management unit 1200, the prefetch management unit 1200 recognizes the request for executing prefetch in step 1201 of FIG. 12.

FIG. 12 illustrates a flowchart of a process of the prefetch management unit 1200, which is a functional unit realized by the storage management server 250. Each step illustrated in FIG. 12 may constitute a “prefetch management step”.

In step 1201 of FIG. 12, the prefetch management unit 1200 determines whether a request for executing prefetch has been received from (the prefetch request unit 1100 of) the compute management server 220. When the determination result in step 1201 is positive, the control proceeds to step 1202. When the determination result in step 1201 is negative, step 1201 is repeated.

In step 1202 of FIG. 12, the prefetch management unit 1200 grasps a free area of a storage that can be used to store data (file) scheduled to be transferred from the secondary storage 240 in each of the storage servers 231 forming the primary storage 230. Then, the prefetch management unit 1200 grasps a size of the free space (free size (A)). In FIG. 9, the area in which the data entity 920 is stored is not set as a free area, whereas the area in which the invalid data 930 exists may be set as a free area.

In step 1203 of FIG. 12, the prefetch management unit 1200 grasps data (file) that is in the cache state 902 but can transition to the stub state 903 in each of the storage servers 231 forming the primary storage 230. Then, the prefetch management unit 1200 grasps a data size (a stubbable size (B)) occupied by the data entity 920 of the data (file) in the primary storage 230.

Here, the data (file) that is in the cache state 902 but can transition to the stub state 903 may be, for example, data (file) that is accessed relatively less frequently from the compute server 211 than the other data (file). As the data (file) that is accessed relatively less frequently, for example, least frequently used (LFU) data (file) may be specified.

Alternatively, the data (file) that is in the cache state 902 but can transition to the stub state 903 may be, for example, data (file) to which the most recent access from the compute server 211 was made relatively long time ago. As the data (file) to which the most recent access was made relatively long time ago, for example, least recently used (LRU) data (file) may be specified.

In executing step 1203, the prefetch management unit 1200 may transmit and receive necessary information to and from the file and object management unit 1800 of the primary storage 230.

In step 1204 of FIG. 12, the prefetch management unit 1200 compares the size of the data (file) that is the target of the request for executing prefetch received in step 1201 with the size of the area in which the prefetched data (file) can be stored in the primary storage 230.

For example, the prefetch management unit 1200 calculates the sum of the free size (A) specified in step 1202 and the stubbable size (B) specified in step 1203 as the size (A+B) of the area in which the prefetched data (file) can be stored.

Then, the prefetch management unit 1200 calculates the size (S+α) of the area desired to be reserved, which is the sum of a stub file size 707(S) for the data (file) that is the target of the request for executing prefetch received in step 1201 and a margin size (α).

Then, the prefetch management unit 1200 determines which one is larger between the size (A+B) of the area in which the prefetched data (file) can be stored and the size (S+α) of the area desired to be reserved. When the determination result in step 1204 is that the size (A+B) of the area in which the prefetched data (file) can be stored is larger than the size (S+α) of the area desired to be reserved, the control proceeds to step 1205. Otherwise, the control passes to step 1206.

In step 1205 of FIG. 12, the prefetch management unit 1200 performs control to transfer (stage or prefetch) all data entities 920 of a portion in the stub state 903 of the data (file) that is the target of the request for executing prefetch in the most recent step 1201 from the secondary storage 240 to the primary storage 230. The prefetch management unit 1200 may instruct the file and object management unit 1800 of the primary storage 230 to start the transfer (staging or prefetching).

At this time, the prefetch management unit 1200 may instruct the file and object management unit 1800 of the primary storage 230 to transition, to the stub state 903, the data (file) that is in the cache state 902 in step 1203 but can transition to the stub state 903, as necessary.

Through the processing of steps 1202, 1203, 1204, and 1205 described above, prefetch is started after it is confirmed that all the data entities 920 of the portion in the stub state 903 of the data (file) that is the target of the request for executing prefetch can be stored in the primary storage 230. This increases the safety of the prefetch control.

After step 1205, the control proceeds to step 1207.

In step 1206 of FIG. 12, the prefetch management unit 1200 performs control to transfer (stage or prefetch) a data entity 920 having a size within a range of which the upper limit is the size (A+B) of the area in which the prefetched data (file) can be stored, which is specified in step 1204, in the portion in the stub state 903 of the data (file) that is the target of the request for executing prefetch in the most recent step 1201 from the secondary storage 240 to the primary storage 230.

By performing the control as described above, even in a case where it is not possible to immediately store all the data entities 920 of the portion in the stub state 903 of the data (file) that is the target of the request for executing prefetch in the primary storage 230, the data entities 920 can be made to exist in the primary storage 230 for as much data (file) as possible.

An aspect in which the start of the transfer (staging or prefetching) is instructed or an aspect in which the transition to the stub state 903 is instructed may be similar to that in step 1205 (except for the size of data (file) that is a target of the instruction of the prefetch).

Alternatively, in a modification of step 1206, when step 1206 is reached, the prefetch management unit 1200 may give up all the prefetch corresponding to the request for executing prefetch received in the most recent step 1201. This modification can simplify the control.

After step 1206, the control proceeds to step 1207.

In step 1207 of FIG. 12, the prefetch management unit 1200 reflects a result of the execution of the prefetch or a result of the progress of the prefetch in response to the instruction to start the execution of the prefetch in step 1205 or step 1206 in a record of the job analysis information 700 accessible from the storage management server 250. For example, the prefetch management unit 1200 may update one or a plurality of pieces of information among the data (file) state 900, the stub file size 707, the required prefetch time 708, or the prefetch execution state 709 in FIG. 7. Specifically, by performing the prefetch, the stub file size 707 and the required prefetch time 708 may be reduced.

In step 1208 of FIG. 12, the prefetch management unit 1200 transmits, to (the prefetch request unit 1100 of) the compute management server 220, the information on the result of the execution of the prefetch or the information on the result of the progress of the prefetch used in step 1207. After step 1208, the control of the prefetch management unit 1200 returns to step 1201.

In step 1208 of FIG. 12, in response to the transmission of the information on the result of the execution of the prefetch or the information on the result of the progress of the prefetch from the prefetch management unit 1200 to the prefetch request unit 1100, the prefetch request unit 1100 recognizes the reception of the information on the result in step 1105 of FIG. 11.

In step 1105 of FIG. 11, the prefetch request unit 1100 determines whether the information on the result of the execution of the prefetch or the information on the result of the progress of the prefetch corresponding to the request for executing prefetch in the most recent step 1104 has been received from (the prefetch management unit 1200 of) the storage management server 250. When the determination result in step 1105 is positive, the control proceeds to step 1106. When the determination result in step 1105 is negative, step 1105 is repeated.

In step 1106 of FIG. 11, the prefetch request unit 1100 reflects the information on the result of the execution of the prefetch or the information on the result of the progress of the prefetch received in step 1105 in a record of the job analysis information 700 accessible from the compute management server 220. Through step 1207 in FIG. 12 and step 1106 in FIG. 11, the two pieces of job analysis information 700 have substantially similar contents. After step 1106, the control of the prefetch request unit 1100 returns to step 1101.

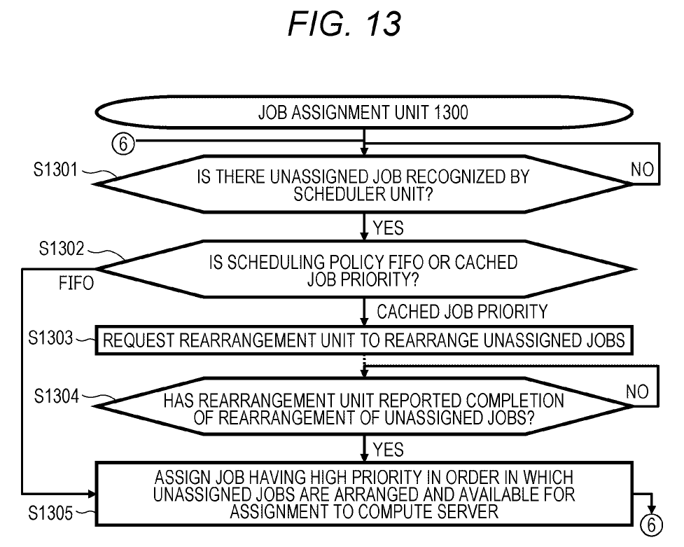

### 2-1-3-3. Job Assignment Unit and Rearrangement Unit (FIGS. 13 to 15)

In this section, a functional configuration (process) realized by the job assignment unit 1300, which is a functional unit realized by the compute management server 220, and the rearrangement unit 1500 (or 1600) in cooperation will be described. Furthermore, information used in the functional configuration (process) will be described.

According to the functional configuration, process, and information to be described below, it is possible to preferentially assign, to the calculation resource 210 (compute server), a job 102 having a relatively small stub file size 707, which is a size of a data entity 920 of a portion that does not exist in the primary storage 230 but exists in the secondary storage 240 among the data entities 920 to be read when the calculation resource 210 (compute server) executes the job 102, or a job 102 having a relatively short required prefetch time 708 for the data of the stub file size 707.

By controlling the assignment of the job 102 as described above, it is possible to increase the possibility that the data entity 920 exists in the primary storage 230 at the timing when the calculation resource 210 (compute server) actually uses the data (file) when executing the job 102. That is, it can be expected that the possibility of stand-by that occurs when the calculation resource 210 (compute server) executes the job 102 will decrease, and the stand-by time will be reduced.

FIG. 13 illustrates a flowchart of a process of the job assignment unit 1300, which is a functional unit realized by the compute management server 220. Each step illustrated in FIG. 13 may constitute a “job assignment step”.

In step 1301 of FIG. 13, the job assignment unit 1300 determines whether there is a job 102 that is recognized by the scheduler unit 221 and that has not yet been assigned to any of the compute servers 211 forming the calculation resource 210 (unassigned job). When the determination result in step 1301 is positive, the control proceeds to step 1302. When the determination result in step 1301 is negative, step 1301 is repeated.

In step 1302 of FIG. 13, the job assignment unit 1300 checks a scheduling policy that is a guideline when a job 102 is assigned to each of the compute servers 211 forming the calculation resource 210. For example, the job assignment unit 1300 may grasp the currently applied scheduling policy by checking the type of scheduling policy described in the scheduling policy setting file 1400.

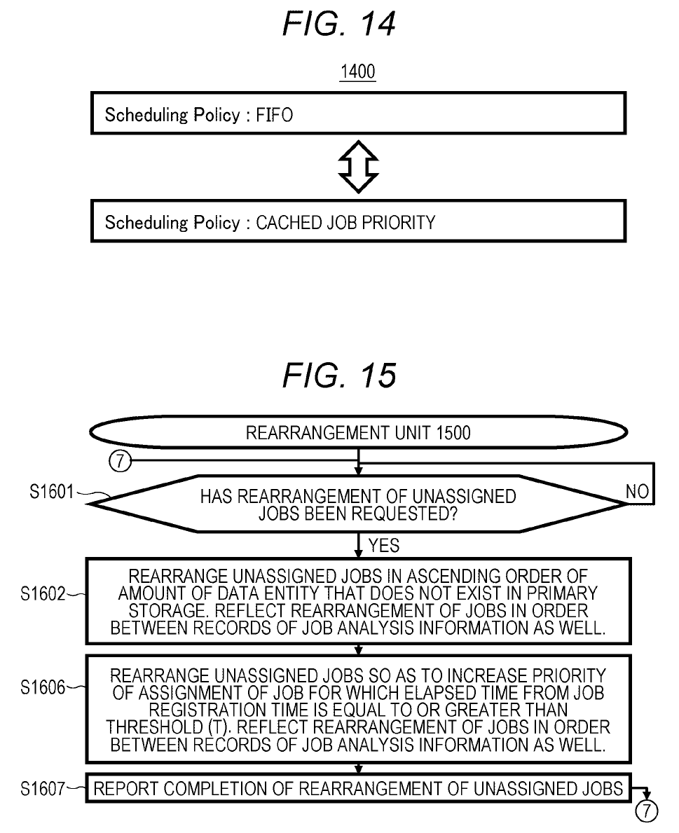

FIG. 14 illustrates a scheduling policy setting file 1400. As illustrated in FIG. 14, the term for the type of scheduling policy itself may be described in the scheduling policy setting file 1400. (A number or a symbol according to the type of scheduling policy may be described in the scheduling policy setting file 1400.) The upper part of FIG. 14 illustrates an example in which “FIFO” (FIFO policy) is described as the term for the type of scheduling policy. The lower part of FIG. 14 illustrates an example in which “cached job priority” (cached job priority policy) is described as the term for the type of scheduling policy. There may also be types of scheduling policies other than “FIFO” and “cached job priority”.

The “FIFO”, which is a type of scheduling policy, is a guideline for assigning jobs 102 to the compute servers 211 in the order in which the scheduler unit 221 receives the jobs 102. On the other hand, the “cached job priority”, which is a type of scheduling policy, is a policy of preferentially assigning, to the compute server 211, a job 102 for which a data entity 920 has a relatively small size in a portion where the data entity 920 does not exist in the primary storage 230 and the data entity 920 exists in the secondary storage 240 of the data (file) to be read when the compute server 211 executes the job 102.

Note that, in FIG. 13, it seems that the job assignment unit 1300 determines the type of scheduling policy every time the control proceeds to step 1302, but the job assignment unit 1300 may determine the type of scheduling policy only once when the job assignment unit 1300 is activated (alternatively, when scheduler unit 221 is activated). Alternatively, the job assignment unit 1300 may determine the type of scheduling policy once every time the control proceeds to step 1302 occurs a predetermined number of times. Alternatively, the job assignment unit 1300 may determine the type of scheduling policy when receiving an explicit instruction from a user of the management system 101.

When the type of scheduling policy is “FIFO” as a result of the determination in step 1302, the control proceeds to step 1305 (skipping steps 1303 and 1304). When the type of scheduling policy is “cached job priority” as a result of the determination in step 1302, the control proceeds to step 1303.

In step 1303 of FIG. 13, the job assignment unit 1300 requests the rearrangement unit 1500 (or 1600) to rearrange the unassigned jobs in order to realize “cached job priority” as the scheduling policy. The rearrangement of the unassigned jobs means that the unassigned jobs are rearranged in descending order of priority (alternatively, the order of assignment) for assignment to one of the compute servers 211 forming the calculation resource 210.

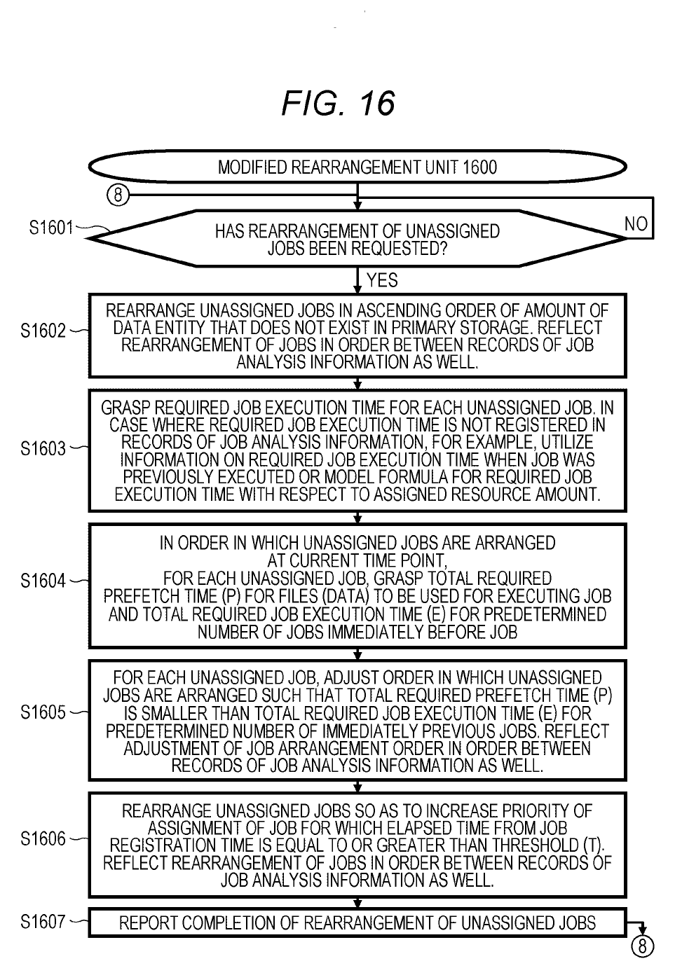

In step 1303 of FIG. 13, in response to the request for rearranging unassigned jobs from the job assignment unit 1300 to the rearrangement unit 1500, the rearrangement unit 1500 recognizes in step 1601 of FIG. 15 (alternatively, in step 1601 of FIG. 16) that the request for rearranging jobs has been made.

FIG. 15 illustrates a flowchart of a process of the rearrangement unit 1500 realized as a functional unit in the compute management server 220. Each step illustrated in FIG. 15 may constitute a “rearrangement step”.

In step 1601 of FIG. 15, the rearrangement unit 1500 determines whether rearrangement of unassigned jobs has been requested from the job assignment unit 1300. When the determination result in step 1601 is positive, the control proceeds to step 1602. When the determination result in step 1601 is negative, step 1601 is repeated.

In step 1602 of FIG. 15, for each of the unassigned jobs that are targets of the rearrangement, the rearrangement unit 1500 grasps the stub file size 707, which is a data size of a portion of the data (file) to be read when the unassigned job is executed, where the data entity 920 does not exist in the primary storage 230 and the data entity 920 exists in the secondary storage 240. When there are a plurality of pieces of data (file) to be read for one unassigned job, the rearrangement unit 1500 may grasp a total stub file size 707 of the data (file) to be read.

Then, the rearrangement unit 1500 rearranges the unassigned jobs in ascending order of (total) stub file size 707 corresponding to each of the unassigned jobs. That is, the rearrangement unit 1600 assigns a high priority (earlier order) to an unassigned job having a small (total) stub file size 707 as the priority or order of assignment to the compute servers 211.

Here, the rearrangement unit 1500 may also rearrange records of the job analysis information 700 accessible from the compute management server 220 so as to reflect the rearrangement of the unassigned jobs. After step 1602, the control proceeds to step 1606.

In step 1606 of FIG. 15, the rearrangement unit 1500 may adjust the priority or order in which the unassigned jobs are arranged after the rearrangement in step 1602 such that an unassigned job that has been on standby for an excessively long time is taken into account for assignment to the compute server 211 forming the calculation resource 210. Specifically, the rearrangement unit 1600 recognizes an unassigned job for which an elapsed time (elapsed stand-by time for assignment) from the job registration time 702 of the unassigned job is equal to or greater than a threshold (T), among the unassigned jobs. The rearrangement unit 1500 adjusts the priority (or order) of the unassigned job so as to increase the priority of assignment of the grasped unassigned job or to move the grasped unassigned job to an earlier assignment order.

Here, the rearrangement unit 1500 may also rearrange the records of the job analysis information 700 accessible from the compute management server 220 so as to reflect the adjustment of the priority or order between the unassigned jobs.

By performing the processing of step 1606, it is possible to prevent an occurrence of a job 102 that has been on standby for an excessively long time for assignment to the compute server 211 forming the calculation resource 210 due to some circumstances (for example, circumstances in which the (total) stub file size 707 is large and the required prefetch time 708 is long).

In step 1607 of FIG. 15, the rearrangement unit 1500 reports the completion of the rearrangement of the unassigned jobs to the job assignment unit 1300. After step 1607, the control of the rearrangement unit 1500 returns to step 1601.

In response to the report of the completion of the rearrangement of the unassigned jobs from the rearrangement unit 1500 to the job assignment unit 1300 in step 1607 of FIG. 15, the job assignment unit 1300 recognizes that the completion of the rearrangement of the jobs has been reported in step 1304 of FIG. 13.

In step 1304 of FIG. 13, the job assignment unit 1300 determines whether the rearrangement unit 1500 (or 1600) has reported the completion of the rearrangement of the unassigned jobs. When the determination result in step 1304 is positive, the control proceeds to step 1305. When the determination result in step 1304 is negative, step 1304 is repeated.

In step 1305 of FIG. 13, the job assignment unit 1300 assigns an unassigned job to the compute server 211, the unassigned job being an unassigned job having a high priority or an early order while being available for assignment to the compute server 211, in the priority or order in which the unassigned jobs are arranged for assignment to the respective compute servers 211 forming the calculation resource 210. Note that the assignment of the unassigned job to the compute server 211 in step 1305 may be performed for one or a plurality of unassigned jobs in every step 1305. After step 1305, the control of the job assignment unit 1300 returns to step 1301.

### 2-1-3-4. Modified Rearrangement Unit (FIGS. 13, 14, and 16)

Among those described in the section “2-1-3-3. Job Assignment Unit and Rearrangement Unit” above, instead of the rearrangement unit 1500 illustrated in the flowchart of the process of FIG. 15, a modified rearrangement unit 1600 illustrated in a flowchart of a process of FIG. 16 to be described below may be used. Hereinafter, a modified rearrangement unit will be described.

According to the functional configuration, process, and information to be described below, in addition to providing the same effects as those of the rearrangement unit 1500, the modified rearrangement unit 1600 can adjust the order in which the jobs 102 are assigned to the calculation resource 210 (compute servers), when setting the order, such that, for each of the jobs 102, the required prefetch time 708 for the job 102 is shorter than the total required job execution time 703, which is a time required to execute a predetermined number of jobs scheduled to be executed immediately before the job 102. For example, it is possible to perform adjustment to change the order in which the jobs 102 are assigned so as to delay the assignment of a job 102 having a relatively long required prefetch time 708 to the calculation resource 210 (compute server). In this manner, by taking into account the required job execution time 703 for each of the unassigned jobs, the modified rearrangement unit 1600 can further contribute to reducing the possibility of stand-by that occurs for reading data (file) or shortening the time required for stand-by when the compute server 211 executes the job 102.

FIG. 16 illustrates a flowchart of a process of the modified rearrangement unit 1600 realized as a functional unit of the compute management server 220. Each step illustrated in FIG. 16 may constitute a “rearrangement step”. In the processing illustrated in FIG. 16, the processing of steps 1601, 1602, 1606, and 1607 is similar to the processing of the steps of the same names illustrated in FIG. 15 (except that the modified rearrangement unit 1600 executes the steps), and thus, the description thereof will be substantially omitted.

After step 1602 of FIG. 16, the control proceeds to step 1603.

In step 1603 of FIG. 16, the modified rearrangement unit 1600 grasps a required job execution time 703 for each of the unassigned jobs. The modified rearrangement unit 1600 may grasp the required job execution time 703 for each of the unassigned jobs based on the items of the required job execution times 703 in the records of the job analysis information 700. Alternatively, the modified rearrangement unit 1600 may acquire information on the required job execution time 703 when each of the unassigned jobs was previously executed from a source other than the records of the job analysis information 700. Alternatively, the modified rearrangement unit 1600 may grasp the amount of resources ((time resources of) GPU, memory, and the like) of the compute server 211 scheduled to be assigned to each of the unassigned jobs, and then calculate the required job execution time 703 by utilizing a model formula between the amount of resources and the required job execution time 703.

In step 1604 of FIG. 16, for each of the unassigned jobs, the modified rearrangement unit 1600 grasps a (total) required prefetch time 708 (P) corresponding to the (total) stub file size 707 of the data (file) to be read when the unassigned job is executed.

Then, for each of the unassigned jobs in the arrangement order according to the priority or order in which the unassigned jobs are assigned, which is determined in step 1602, the modified rearrangement unit 1600 grasps what the predetermined number of unassigned jobs immediately before the unassigned job are. Note that, in a case where there are a plurality of compute servers 211 forming the calculation resource 210, for each compute server 211, it may be grasped for each of the unassigned jobs what the predetermined number of unassigned jobs immediately before the unassigned job are.

Then, for each of the unassigned jobs, the modified rearrangement unit 1600 grasps a (total) required job execution time 703 (E) for the predetermined number of unassigned jobs immediately before the unassigned job.

In step 1605 of FIG. 16, for each of the unassigned jobs, the modified rearrangement unit 1600 determines whether the (total) required prefetch time 708 (P) for the unassigned job is shorter than the (total) required job execution time 703 (E) for the predetermined number of unassigned jobs immediately before the unassigned job. Then, when the determination result is negative, the modified rearrangement unit 1600 adjusts the priority or order in which the unassigned jobs are arranged such that the determination result becomes as positive as possible.

Here, the modified rearrangement unit 1600 may also rearrange the records of the job analysis information 700 accessible from the compute management server 220 so as to reflect the adjustment of the priority or order between the unassigned jobs.

After step 1605, the control proceeds to step 1606.

In step 1606, the modified rearrangement unit 1600 handles the priority or order in which the unassigned jobs are arranged after the adjustment in step 1605.

### 2-2. Second Embodiment

In the second embodiment, a job using data (file) located in a different base 1799 (e.g., a job of analyzing data (file)) can be executed in a base where the calculation resource 210 and the primary storage 1730 (and further, the compute management server 220 and the storage management server 1750) exist.

In the second embodiment, for example, it may be assumed that the calculation resource 210 and the primary storage 1730 (and further, the compute management server 220 and the storage management server 1750) exist in the same base while the secondary storage 1740 (and the storage management server 1790) exists in a different base (different base 1799). The secondary storage 1740 may be a primary storage in the different base 1799 or may be a secondary storage in the different base 1799. The base may be, for example, a data center.

Hereinafter, the second embodiment will be mainly described in terms of differences from the first embodiment. The description of points similar to those in the first embodiment may be omitted.

### 2-2-1. Overall Configuration of Second Embodiment (FIG. 17)

FIG. 17 illustrates an overall configuration 200 of the second embodiment of the present disclosure. Note that not all the functional configurations (and information to be handled) illustrated in FIG. 17 are essential. In addition, the presence of functional configurations other than the functional configurations (and information to be handled) illustrated in FIG. 17 is not precluded.

The second embodiment illustrated in FIG. 17 is greatly different from the first embodiment illustrated in FIG. 2 in that a base where the calculation resource 210 and the primary storage 1730 exist and a base where the secondary storage 1740 exists are different in the second embodiment. In FIG. 17, the base where the secondary storage 1740 exists is referred to as a different base 1799.

One or a plurality of (S in FIG. 17) storage servers 1741 forming the secondary storage 1740 exist in the different base 1799. In addition, a storage management server 1790 for the different base 1799 exists in the different base 1799.

In the second embodiment, a file and object management unit 1743 realized in the secondary storage 1740 has a function similar to that of the file and object management unit 243 realized in the secondary storage 240 in the first embodiment. However, in the second embodiment, as a wide area network (WAN) 1770 is used for mutual communication between the primary storage 1730 and the secondary storage 1740, the file and object management unit 1743 (and the file and object management unit 1800 on the primary storage 1730 side) may have a function corresponding to the mutual communication using the wide area network (WAN) 1770.

The wide area network (WAN) 1770 may have any communication speed, which may be, for example, about 10 gigabits per second.

Instead of the storage management unit 251 in FIG. 2, the storage management server 1750 for the base where the calculation resource 210 and the primary storage 1730 exist includes a hybrid storage management unit 1751, and the storage management server 1790 for the different base 1799 includes a hybrid storage management unit 1791. The hybrid storage management units for different bases cooperate with each other, thereby realizing storage management across the wide area network (WAN) 1770.

In the second embodiment, since the base where the secondary storage 1740 exists is different from the base where the compute server 211 and the primary storage 1730 exist, data (file) of which the data entity 920 does not exist in the primary storage 1730 but the data entity 920 exists in the secondary storage 1740 (or the data entity 920 is scheduled to exist in the secondary storage 1740) is not necessarily managed effectively from the beginning by the file and object management unit 1800 realized in the primary storage 1730.

In order to address the above circumstances, in the second embodiment, the file and object management unit 1800 (and a virtualization and hierarchy control unit 1732 as an internal functional unit thereof) realized in the primary storage 1730 is capable of performing processing for newly effectively managing files corresponding to data in the different base 1799 in a file system provided in the own base. The function (process) and information of the file and object management unit 1800 realized in the primary storage 1730 in the second embodiment will be described in detail in the section “2-2-2. Functional Configurations, Processes, and Information of Second Embodiment” below.

### 2-2-2. Functional Configurations, Processes, and Information in Second Embodiment

Hereinafter, functional configurations, processes, and information of the management system 101 according to the second embodiment will be described.

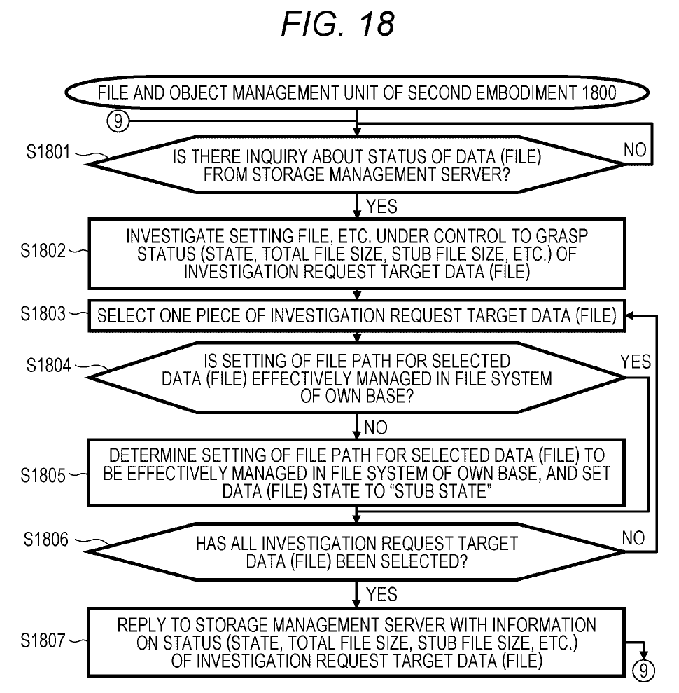

The description in the section “2-1-3-1. Job Analysis Unit and Investigation Unit” in the first embodiment generally applies to the second embodiment, except for the description of the process of the file and object management unit 1000, which is a functional unit realized in the primary storage 230 using FIG. 10. Therefore, in the section of “2-2-2-1. File and Object Management Unit in Second Embodiment” below, the process of the file and object management unit 1800, which is a functional unit realized in the primary storage 1730 according to the second embodiment, will be mainly described with reference to FIG. 18.

The description in the section “2-1-3-2. Prefetch Request Unit and Prefetch Management Unit” in the first embodiment generally applies to the second embodiment. However, in the second embodiment, since the wide area network (WAN) 1770 is used as a transfer path when the transfer (staging or prefetching) of data (file) from the secondary storage 1740 to the primary storage 1730 is executed, the primary storage 1730 and the secondary storage 1740 in the second embodiment perform processing corresponding to the wide area network (WAN) 1770.

The description in the section “2-1-3-3. Job Assignment Unit and Rearrangement Unit” and the section “2-1-3-4. Modified Rearrangement Unit” in the first embodiment generally applies to the second embodiment.

### 2-2-2-1. File and Object Management Unit in Second Embodiment (FIG. 18)

In this section, a functional configuration (process) realized by the job analysis unit 300, which is a functional unit realized by the compute management server 220, the investigation unit 800, which is a functional unit realized by the storage management server 1750, and the file and object management unit 1800, which is a functional unit realized by the primary storage 1730, in cooperation in the second embodiment will be described. Furthermore, information used in the functional configuration (process) will be described.

According to the functional configuration, process, and information to be described below, in addition to providing the same effects as those brought about by the first embodiment, even in a case where data (file) of which the data entity 920 does not exist in the primary storage 1730 and the data entity 920 exists in the secondary storage 1740 (or the data entity 920 is scheduled to exist in the secondary storage 1740) is not effectively managed from the beginning by (the file system provided by) the file and object management unit 1800 realized in the primary storage 1730, files corresponding to the data can be newly effectively managed on the file system. Therefore, even in a system configuration in which the primary storage 1730 and the secondary storage 1740 exist in different bases, prefetch of data (file) can be realized by the same control as in the first embodiment or a similar control.

In the second embodiment, when the job analysis unit 300, the investigation unit 800, and the file and object management unit 1800 cooperate with each other, the processing contents of the job analysis unit 300 and the investigation unit 800 may be similar to those in the first embodiment. That is, in the second embodiment as well, the job analysis unit 300 may be based on the flowchart of the process illustrated in FIG. 3, and the investigation unit 800 may be based on the flowchart of the process illustrated in FIG. 8.

FIG. 18 illustrates a flowchart of a process of the file and object management unit 1800, which is a functional unit realized by each of the storage servers 1731 forming the primary storage 1730 in the second embodiment. Each step illustrated in FIG. 18 may constitute a “file and object management step”. In the processing illustrated in FIG. 18, the processing of steps 1801, 1802, and 1807 is similar to that of FIG. 10 (except that the file and object management unit 1800 executes the steps), and thus, the description thereof will be substantially omitted.

Note that, among the data (file) that is an investigation request target for which the inquiry about the status of the data (file) has been made in the most recent step 1801, there may be data (file) for which the file path 705 has not yet been effectively managed in the file system provided by the file and object management unit 1800 in step 1802 of FIG. 18.

After step 1802 of FIG. 18, the control proceeds to step 1803.

In step 1803 of FIG. 18, the file and object management unit 1800 selects one piece of the data (file) that is an investigation request target for which the inquiry has been made in the most recent step 1801 about the status of the data (file).

In step 1804 of FIG. 18, the file and object management unit 1800 determines whether the setting of the file path 705 for the data (file) selected in the most recent step 1803 is effectively managed in the file system (the file system in the own base) provided by the file and object management unit 1800. For example, the file and object management unit 1800 determines whether valid management information 910 corresponding to the file path 705 is held in a setting file or the like under the file and object management unit 1800. When the determination result in step 1804 is positive, the control proceeds to step 1806 (skipping step 1805). When the determination result in step 1804 is negative, the control proceeds to step 1805.

In step 1805 of FIG. 18, the file and object management unit 1800 determines the setting of the file path 705 for the data (file) selected in the most recent step 1803 to be effectively managed in the file system (the file system in the own base) provided by the file and object management unit 1800. For example, when the data entity 920 related to the data (file) selected in the most recent step 1803 exists in the secondary storage 1740 (alternatively, it is scheduled to exist in the secondary storage 1740), the file and object management unit 1800 sets the data (file) state 900 to the “stub state” in the management information 910 for the file path 705, and stores information related to the location of the data entity 920 in the management information 910. After step 1805, the control proceeds to step 1806.

Note that, in a case where big data that can be learning data for machine learning is scheduled to be stored in the secondary storage 1740 from a big data generation source or the like, the big data can be assumed as an example of data (file) of which the data entity 920 is scheduled to exist in the secondary storage 1740.

In step 1806 of FIG. 18, the file and object management unit 1800 determines whether all the data (file) that is an investigation request target for which the inquiry has been made in the most recent step 1801 about the status of the data (file) has been selected in step 1803. When the determination result in step 1806 is positive, the control proceeds to step 1807. When the determination result in step 1806 is negative, the control returns to step 1803 to newly select one piece of the data (file) that has not yet been selected.

### 3. Other (Modification)

The present disclosure is not limited to the above-described embodiments, and includes various modifications. Some of the configurations and processes of the embodiments may be replaced with possible configurations and processes of other embodiments. Possible configurations and processes of other embodiments may be added to the configurations and processes of the embodiments.

For example, the present disclosure may include the following modifications of the embodiments.

### (Modification A) Integration of Servers

In the embodiment described above, each of the compute servers 211 forming the calculation resource 210, each of the storage servers 231 (or 1731) forming the primary storage 230 (or 1730), each of the storage servers 241 (or 1741) forming the secondary storage 240 (or 1740), the compute management server 220, and the storage management server 250 (or 1750) are illustrated.

In Modification A, some of the various servers described above may be integrated in hardware. For example, by having any one of the compute servers 211 fulfill the role of the compute management server 220, the compute management server 220 may not exist as hardware. Alternatively, by having any one of the storage servers 231 (or 1731) fulfill the role of the storage management server 250 (or 1750), the storage management server 250 (or 1750) may not exist as hardware.

According to Modification A, the system configuration of the embodiment of the present disclosure can be flexibly determined, and the hardware cost can be reduced.

### (Modification B) Specific Modification of Data by Job Analysis Unit

In the embodiment described above, the job analysis unit 300 analyzes a workflow of a job 102 to specify data (file) to be read when the calculation resource 210 (compute server) executes the job 102.

In Modification B, the job analysis unit 300 may specify data (file) to be read when the calculation resource 210 (compute server) executes the job 102, using a method other than the method of analyzing the workflow of the job 102 (for example, a method based on access patterns in past executions of the job 102 (based on historical analysis)).

In Modification B as well, before the calculation resource 210 (compute server) starts the execution of the job 102, data (file) to be read when the calculation resource 210 (compute server) executes the job 102 is specified, and prefetch of the specified data (file) is started. Therefore, as compared with a case where prefetch of data (file) is started after the execution of the job 102 is started, the possibility that the storage (primary storage) in the hierarchy relatively close to the calculation resource 210 (compute server) may hold the data (file) at the timing when the data (file) is used to execute the job 102 can be increased in Modification B as well.

The technical matters described in each of the embodiments and the modifications of the embodiments of the present disclosure as described above can be appropriately combined as long as no technical contradiction occurs.

What is claimed is:

1. A management system that manages a calculation resource and a storage, the management system comprising:
a job analysis unit configured to analyze a workflow of a job before starting execution of the job to specify data to be read when the calculations resource executes the job; and
a prefetch management unit configured to perform control to start prefetch from a secondary storage to a primary storage for data of which no data entities exist in the primary storage having relatively high performance of access from the calculation resource and data entities exist in the secondary storage having relatively low performance of access from the calculation resource and data entities exist in the secondary storage having relatively low performance of access from the calculation resource, among the dada specified by the job analysis unit for the job.

2. The management system according to claim 1, wherein the job is for performing processing related to a model or data related to artificial intelligence.

3. The management system according to claim 1, wherein the job analysis unit analyzes information describing the workflow of the job, refers to an argument of a command for calling the job, or acquires specific information of data to be read, the specific information of the data being described in a setting file for the job, to specify data to be read when the calculation resources executes the job.

4. The management system according to claim 1, wherein
the management system includes an investigation unit configured to, for each piece of the data to be read when the calculation resource executes the job, which is specified by the job analysis unit, investigate a status of the data in the primary storage and the secondary storage,
the status of the data to be investigated by the investigation unit includes a state of the data indicating whether data entities exist in the primary storage or the secondary storage, and a stub file size indicating a size of a data entity in a portion that exists in the secondary storage but does not exist in the primary storage among the data entities,
the investigation unit calculates a required prefetch time required for transferring, from the secondary storage to the primary storage, the data entity in the portion that exists in the secondary storage but does not exist in the primary storage among the data entities by using the stub file size, and
the prefetch is controlled based on the required prefetch time.

5. The management system according to claim 4, wherein a set of states in which the data can be formed includes at least a non-hierarchical state, a cache state, and a stub state, the non-hierarchical state indicates that data entities exist in the primary storage but do not exist in the secondary storage, the cache state indicates that data entities exist in both the primary storage and the secondary storage, and the stub state indicates that data entities exist in the secondary storage but do not exist in the primary storage, with management information of the data existing in the primary storage.

6. The management system according to claim 4, wherein the system includes job analysis information having a record for each piece of the data to be read when the calculation resource executes the job, and each record of the job analysis information holds information on the state of the data corresponding to the record, the stub file size of the data corresponding to the record, and the required prefetch time for the data corresponding to the record.

7. The management system according to claim 4, wherein the job analysis unit, the prefetch management unit, the investigation unit, the primary storage, a file and object management unit for the primary storage, and the calculation resource that executes the job exist in the same base, while the secondary storage exists in a different base, the investigation unit inquires of the file and object management unit for the primary storage about the status of the data, and when a setting of a file path of a file related to the inquired data is not effectively managed in a file system in the same base, the file and object management unit for the primary storage determines to effectively manage the setting of the file path and sets the state of the data to the stub state.

8. The management system according to claim 1, further comprising a scheduler unit configured to assign jobs to the calculation resource to execute the jobs, wherein the scheduler unit includes a prefetch request unit configured to, for a job that has not yet been assigned to the calculation resource, request the prefetch management unit to start prefetch of data to be read when the job is executed.

9. The management system according to claim 8, wherein the scheduler unit follows scheduling policies when assigning the jobs to the calculation resource, and one of the scheduling policies that is usable by the scheduler unit is a cached job priority policy indicating a policy for preferentially assigning, to the calculation resource, a job having a relatively small stub file size indicating a size of a data entity in a portion that exists in the secondary storage but does not exist in the primary storage among the data entities of the data to be read when the job is executed, or a job having a relatively short required prefetch time indicating a time required to transfer the data entity having the stub file size from the secondary storage to the primary storage.

10. The management system according to claim 9, wherein the scheduler unit includes a rearrangement unit configured to adjust an order in which the jobs are assigned to the calculation resource when following the cached job priority policy, and for a job that has been on standby for assignment to the calculation resource for a time elapsed beyond a threshold value when following the cached job priority policy, the rearrangement unit performs adjustment to increase a priority for assigning the job to the calculation resource.

11. The management system according to claim 9, wherein when following the cached job priority policy, the rearrangement unit adjusts the order in which the jobs are assigned to the calculation resource in such a manner that, for each of the jobs assigned to the calculation resource, the required prefetch time for the job is shorter than a total required job execution time, which is a time required to execute a predetermined number of jobs scheduled to be executed immediately before the job.

12. The management system according to claim 1, wherein the prefetch management unit specifies a size of an area of the primary storage available for storing data prefetched from the secondary storage, the area of the primary storage available for storing the prefetched data includes one or both of a free area in the primary storage and an area storing target data of which data entities are invalid in the primary storage, and when the area of the primary storage available for storing the prefetched data has a size larger than a sum of a size of data to be prefetched and a predetermined margin, the prefetch management unit performs control to prefetch data entities of the data to be prefetched from the secondary storage to the primary storage.

13. The management system according to claim 12, wherein when the area of the primary storage available for storing the prefetched data has a size equal to or smaller than the sum of the size of data to be prefetched and the predetermined margin, the prefetch management unit performs control to prefetch, from the secondary storage to the primary storage, only a data entity in a portion storable in the area of the primary storage available for storing the prefetched data, among the data to be prefetched.

14. A method executed by a management system that manages a calculation resource and a storage, the method comprising: a job analysis step of analyzing a workflow of a job before starting execution of the job to specify data to be read when the calculation resource executes the job; and a prefetch management step of performing control to start prefetch from a secondary storage to a primary storage for data of which no data entities exist in the primary storage having relatively high performance of access from the calculation resource and data entities exist in the secondary storage having relatively low performance of access from the calculation resource, among the data specified in the job analysis step for the job.
